(19) United States
(12) Patent Application Publication
(10) Pub. No.: US 2013/0078193 A1
(43) Pub. Date: Mar. 28, 2013

(54) Sweetener Compositions, Methods of Making Same and Consumables Containing Same

(71) Applicant: Johann Wonschik, Brevorde (DE)

(72) Inventor: Johann Wonschik, Brevorde (DE)

(73) Assignee: Nutrinova Nutrition Specialties & Food Ingredients Gmbh, Frankfurt am Main (DE)

(21) Appl. No.: 13/624,068

(22) Filed: Sep. 21, 2012

Related U.S. Application Data
(60) Provisional application No. 61/537,795, filed on Sep. 22, 2011.

(30) Foreign Application Priority Data
Sep. 22, 2011 (EP) 11007735.1

(51) Int. Cl. A23L 1/236; A61Q 11/00; A61K 8/73; A23L 1/09; A61C 15/04

(52) U.S. Cl. 424/49; 426/548; 426/661; 426/573; 426/618; 426/549; 426/619; 426/639; 426/660; 426/3; 426/631; 426/659; 426/571; 426/580; 426/583; 426/567; 426/582; 426/635; 132/321

(57) ABSTRACT

In one embodiment, the invention is to a sweetener composition comprising at least one sweetener and a pregelatinized starch, in particular to novel sweetener compositions that have a prolonged sweetener release rate and that provide a prolonged sweetening sensation to the consumer. The pregelatinized starch comprises particles having a plurality of pores having a specific average pore diameter. The sweetener is disposed in at least one of the pores. At least 50% of the particles has an average particle size of at least 50 microns.

### CROSS REFERENCE TO RELATED APPLICATIONS

This application claims priority to U.S. Provisional Patent Application No. 61/537,795, which was filed on Sep. 22, 2011 and to European Patent Application No. 11007735.1, which was filed on Sep. 22, 2011. The entireties of these applications are incorporated herein by reference.

### FIELD OF THE INVENTION

The present invention relates to novel sweetener compositions comprising at least one sweetener and a pregelatinized starch, in particular to novel sweetener compositions that have a prolonged sweetener release rate and that provide a prolonged sweetening sensation to the consumer. The present invention further relates to uses of the novel sweetener compositions and to methods of making the novel sweetener compositions. In addition, the present invention relates to consumable products comprising the novel sweetener compositions.

### BACKGROUND OF THE INVENTION

Conventional caloric sweeteners, such as granulated sugar (sucrose) or high-fructose corn syrup (HFCS), are often used in consumable products to add to or improve the flavor thereof, e.g., to sweeten. In addition to caloric sweeteners, many non-caloric, high intensity sweeteners are also known and are used for similar purposes. These non-caloric, high intensity sweeteners are known to have sweetness levels or “sweetnesses” that are significantly higher than those of conventional sweeteners. These non-caloric sweeteners often are added to the consumable products to replace at least a portion of the conventional caloric sweeteners, which results in a consumable product having a sweet flavor and a reduced amount of caloric sweetener. Acesulfame potassium is an exemplary non-caloric, high intensity sweetener. Typically, the caloric sweeteners and/or the non-caloric sweeteners are combined with other components, e.g., surfactants, emulsifiers, gums, or other sweeteners, to form sweetener compositions. These other components often improve the physical or chemical properties of the caloric or non-caloric sweetener. The sweetener compositions then may be incorporated into the respective consumable product. In most cases, the sweetener or the sweetness associated therewith is released from the consumable product quickly upon consumption of the consumable product. This release accounts for the sweetness realized by the consumer.

For some consumable products, e.g., chewing gum and other confections, once the consumable product begins to be consumed, it is desirable to have a prolonged release rate of sweetener from the consumable product. As a result, the sensation of sweetness is enjoyed by the consumer over a prolonged period of time. Conventional sweeteners, however, have been known to have more rapid release rates from the respective consumable product. As such, a majority of the sweetener is quickly released from the consumable product immediately upon consumption and very little sweetener then is left to be released during the remainder of the lifetime of the consumable product. As one example, a chewing gum comprising a conventional sweetener composition is often considered to be very sweet as the gum is initially chewed, but after some minutes of chewing, the gum is considered to be significantly less sweet.

Thus, a need exists for sweetener compositions that employ sweeteners, e.g., non-caloric, high intensity sweeteners, and that provide for prolonged release rates of these sweeteners from a consumable product. As such, a prolonged sweetening sensation is realized by the consumer.

The references mentioned above are hereby incorporated by reference.

### BRIEF DESCRIPTION OF DRAWINGS

The invention is described in detail below with reference to the appended drawings, wherein like numerals designate similar parts.

FIG. 1 is a magnified photograph of a particle of the sweetener composition in accordance with an embodiment of the present invention.

FIG. 2 is a magnified photograph of a particle of the sweetener composition in accordance with an embodiment of the present invention.

### SUMMARY OF THE INVENTION

The present invention, in one embodiment, is to a sweetener composition. The sweetener composition comprises at least one sweetener and a pregelatinized starch. The pregelatinized starch comprises particles each having a plurality of pores. In one embodiment, at least 50% of the particles has an average particle size of at least 50 microns. In one embodiment, the pores have an average pore diameter ranging from 1 microns to 200 microns. In one embodiment, the at least one sweetener is disposed in at least one of the pores. Preferably, the at least one sweetener is acesulfame potassium. In another preferred embodiment, the at least one sweetener is sucrose. In a preferred embodiment, the at least one sweetener comprises a first sweetener and a second sweetener. Preferably, the first sweetener is acesulfame potassium and the second sweetener is sucralose. In one embodiment, the sweetener composition comprises from 1 wt % to 45 wt % of at least one sweetener. In another embodiment, the sweetener composition comprises from 50 wt % to 99 wt % of pregelatinized starch. The pregelatinized starch, when combined with the at least one sweetener, provides for prolonged release of the at least one sweetener from a consumable product and for a prolonged sweetening sensation realized by the consumer.

In another embodiment, the present invention is to a method of controlling the release rate of taste sensations, e.g., sweetness, associated with a sweetener from a sweetener composition comprising the at least one sweetener. The method comprises the step of admixing the sweetener with a pregelatinized starch to form a release controlled sweetener composition.

In another embodiment, the present invention is to a method of controlling the release rate of taste sensations associated with at least one sweetener from a consumable product. The method comprises the step of combining the at least one sweetener, a pregelatinized starch, and the consumer product to form a released controlled consumer product. Preferably, the at least one sweetener and the pregelatinized starch are combined to form the sweetener composition, which may then be combined with the consumable product.

In another embodiment, the present invention is to a method for decreasing a release rate of the least one sweetener from a consumable product composition comprising a consumable product and a sweetener. The consumable product composition has an initial release rate of the least one sweetener from the consumable product composition. The method comprises the step of adding to the consumer product composition a pregelatinized starch in an amount effective to decrease the release rate of sweetener from the consumable product to final release rate.

In another embodiment, the present invention is to a consumable product composition. The consumable product composition comprises a consumable product, at least one sweetener, and a pregelatinized starch. The pregelatinized starch is present in an amount effective to control the release rate of the at least one sweetener from the consumable product. Preferably, the consumable product is chewing gum and the at least one sweetener is acesulfame potassium. In a particularly preferred embodiment, the consumable product is chewing gum and the at least one sweetener comprises a first sweetener and a second sweetener. Preferably, the first sweetener is acesulfame potassium and the second sweetener is sucralose. In another preferred embodiment, the consumable product is chewing gum and the sweetener is sucrose.

### DETAILED DESCRIPTION OF THE INVENTION

### Introduction

As indicated above, there is a need for alternative sweetener compositions, e.g., high intensity sweetener compositions that may be healthier than conventional sweetener compositions. Conventional sweetener compositions often comprise significant amounts of caloric sweeteners, e.g., granulated sugar (sucrose) or high-fructose corn syrup (HFCS). These sweetener compositions may be combined with various consumable products to add or improve flavor, e.g., sweetness. There is also a need for sweetener compositions that provide for a prolonged release rate of the sweetener from a consumable to the palate of the consumer. As such, the sweetness associated with the sweetener composition may be recognized by the consumer over a longer period of time and as a result a prolonged sweetening sensation is realized by the consumer. It is therefore an object of the present invention to provide alternative sweetener compositions having the aforementioned desired characteristics.

In one embodiment, the present invention is to a sweetener composition comprising at least one sweetener and a pregelatinized starch. The pregelatinized starch comprises particles and each of the particles has a plurality of pores. In one embodiment, at least 50%, e.g., at least 75% or at least 90%, of the particles has an average particle size of at least 50 microns, e.g., at least 100 microns, or at least 250 microns. In one embodiment, the starch particles may have particle sizes of greater than 50 microns, e.g., greater than 100 microns, or greater than 250 microns. In one embodiment, at least a portion of the starch particles may have an average particle size ranging from 50 microns to 1000 microns, e.g., from 50 microns to 750 microns or from 100 microns to 500 microns. In terms of upper limits, the starch particles may have particle sizes of less than 1000 microns, e.g., less than 750 microns, or less than 500 microns. The average particle size of the pores may, for example, be determined by sieve analysis.

The pores of the pregelatinized starch particles may have an average pore size, e.g., an average pore diameter, ranging from 1 microns to 200 microns, e.g., from 5 microns to 100 microns, or from 10 microns to 50 microns. In terms of upper limits, the pores may have an average pore diameter less than 200 microns, e.g., less than 100 microns or less than 50 microns. In terms of lower limits, the pores may have an average pore diameter of at least 1 micron, e.g., at least 5 microns or at least 10 microns. In a preferred embodiment, at least some of the pregelatinized starch particles are in the form of flakes.

It has now been found that the combination of at least one sweetener and pregelatinized starch having a specific particle size, and optionally a specific average pore diameter, in accordance with the invention, demonstrates a beneficial effect, e.g., the sweetener composition, when utilized in a consumable product, demonstrates a prolonged release rate of the at least one sweetener from the consumable product. Without being bound by theory, it is believed that particles of the at least one sweetener may contact and interact with the particles of the pregelatinized starch (and the pores thereof) in a manner such that the particles of the at least one sweetener are uniquely retained by the pregelatinized starch. For example, the at least one sweetener does not freely release out of the pores nor does the at least one sweetener remain in the pores over extended periods of time, e.g., greater than 12 hours or greater than 24 hours. Surprisingly and unexpectedly, the unique retention characteristics of the pregelatinized starch particles provide for the retention of at least a portion of the at least one sweetener in the starch and the release of portions of the at least one sweetener at a controlled rate. Parameters for the controlled rate are discussed herein. Thus, the selection of particle sizes, optionally pore sizes, and sweeteners in accordance with the invention provides for the surprising, synergistic effect.

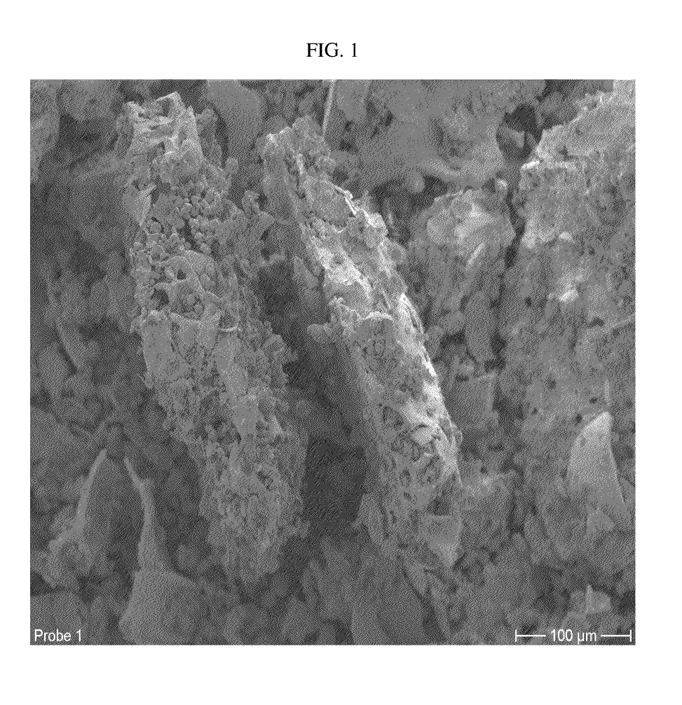

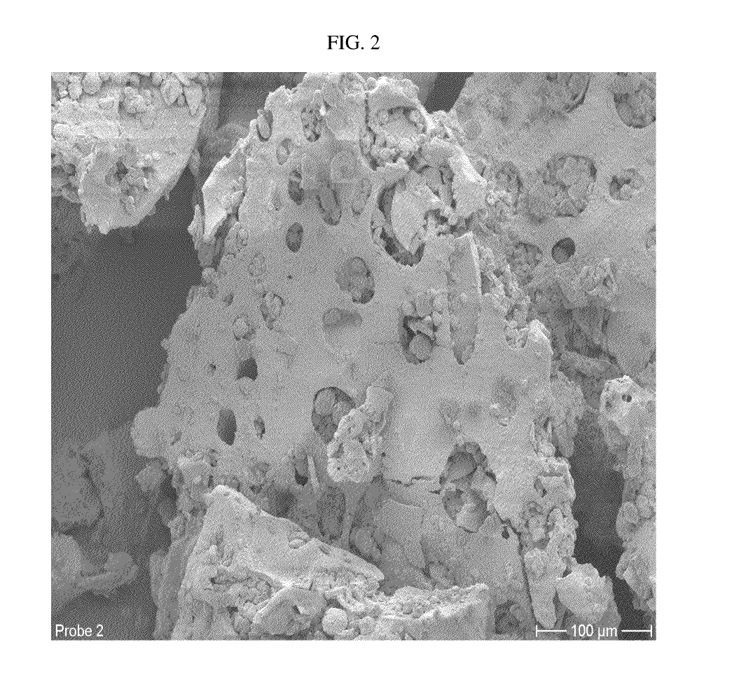

In a preferred embodiment, at least one sweetener is disposed in at least one of the pores. For example, the at least one sweetener may be disposed in at least 5% of the pores, e.g., at least 10%, at least 25%, at least 35%, or at least 45%. Preferably, at least one sweetener is disposed in a majority of the pores, e.g., at least 50%, at least 60%, at least 70%, at least 80%, or at least 90%. Without being bound by theory, the amount of the at least one sweetener that is disposed in the pores of the pregelatinized starch may affect the release rate of sweetener. For example, higher percentages of sweetener disposed in pores (as opposed to being disposed on the surface of the pregelatinized starch) may provide for more prolonged release rates. FIG. 1 shows a highly magnified photograph of a particle of the sweetener composition in accordance with an embodiment of the present invention. In FIG. 1, some of the rounder-shaped sweetener particles are disposed in the pores of the pregelatinized starch particle and some of the sweetener particles are disposed on the surface of the pregelatinized starch particle. In this embodiment, a lower percentage of the at least one sweetener is disposed in the pores of the pregelatinized starch. FIG. 2 shows highly magnified photograph of another particle of the sweetener composition in accordance with an embodiment of the present invention. In FIG. 2, a majority of the rounder-shaped sweetener particles are disposed in the pores of the pregelatinized starch. A higher percentage of the at least one sweetener is disposed in the pores of the pregelatinized starch, as compared to the sweetener composition particle of FIG. 1. FIGS. 1 and 2 show two specific examples of the sweetener compositions of the present invention and are not meant to limit the scope of the present invention.

Preferably, the at least one sweetener is acesulfame potassium. Acesulfame potassium is a commercially available high intensity sweetener. In another preferred embodiment, the at least one sweetener comprises sucrose, which is commercially available. In a particularly preferred embodiment, the at least one sweetener comprises a first sweetener and a second sweetener. Preferably, the first sweetener is acesulfame potassium and the second sweetener is sucralose. Sucralose is commercially available. In one embodiment, the at least one sweetener present in the pores of the pregelatinized starch is in (solid) powder form, e.g., the at least one sweetener is not liquid in form.

Pregelatinized starches are known commodities. As one example, WO 89/04842 discloses amylase treated granular starches that provide a microporous matrix material adapted for absorption and releasable containment of functional compositions. The microporous starch granules are chemically derivatized to enhance absorption and structural properties. Absorbed functional substances are released from the microporous starch matrix under the influence of mechanical compression, by diffusion into a surrounding fluid or as a result of degradation of the granular starch matrix. Also, WO 2009/103514 discloses a liquid loaded starch material comprising a solid carrier material consisting of pregelatinized, non-granular starch material, which consists of flake-shaped starch particles, wherein the size distribution of the starch particles is such that at least 50% by weight of the starch particles have a particle size of between 100 and 375 μm, and wherein the BET specific surface area is less than or equal to 0.5 m²/g and one or more liquid components. This reference also provides for the use of same in food and animal feed products, pharmaceuticals, nutraceuticals, agrochemicals, and cosmetic or personal care products. The reference also provides a process for preparing said powdered liquid-loaded starch material. In addition, U.S. Pat. No. 5,919,486 discloses a “liquid oil and fat ingredient or others” that are carried by pores of a porous carrier composed of porous starch grain obtained by reacting an enzyme having raw starch digestive activity “onto the starch.” These references, however, do not disclose the combination of pregelatinized starches with sweeteners, e.g., non-caloric, high intensity sweeteners, such as acesulfame potassium nor do these references disclose that functional compositions, liquid components, and/or liquid oil and fat ingredients will behave in a manner similar to the sweeteners of the present invention. Importantly, these references fail to disclose preferred particle size ranges and/or average pore size ranges and fail to disclose relationships between starch particle size, pore size, sweetener(s), and/or accompanying sweetener release rates. The references mentioned above are hereby incorporated by reference. A particular preferred pregelatinized starch is Starrier R, which is commercially available.

In one embodiment, the sweetener composition of the present invention demonstrates a prolonged release rate from the consumable product. In one embodiment, the consumable product comprises the sweetener composition and the sweetener composition provides for an initial sweetness level. Sweetness levels, e.g., “sweetnesses,” may be determined by tasting panels, as discussed below. Over time, as the consumable product continues to be consumed, the initial sweetness level decreases, in particular slowly, to a reduced sweetness level. For example, the reduced sweetness level, e.g., after 10 minutes, may be greater than 70% of the initial sweetness level, e.g., greater than 70.2%, greater than 80%, greater than 85%, greater than 90%, or greater than 95%. In one embodiment, the consumable product retains, e.g., after 10 minutes, greater than 70% of the initial sweetness level, e.g., greater than 70.2%, greater than 80%, greater than 85%, greater than 90%, or greater than 95%. In preferred embodiments, the initial sweetness level is essentially maintained over time. In one embodiment, the inventive sweetener composition releases from the consumable product over a prolonged time period. Preferably, the inventive sweetener releases from the consumer product over a time period that is at least 5% longer than the time period for a conventional sweetener composition (employed in similar amounts and in a similar consumable product) that does not comprise the pregelatinized starch of the present invention, e.g., at least 10% longer, at least 20% longer, at least 30% longer, or at least 50% longer.

In one embodiment, a level of mouthfeel of the sweetener composition is prolonged by the addition the pregelatinized starch. In one embodiment, when employed in a chewing gum, the inventive sweetener composition will provide a bulkier and/or a heavier final chewing gum.

Preferably, the sweetener composition comprises from 5 wt % to 30 wt % at least one sweetener based on the total weight of the sweetener composition, e.g., from 5 wt % to 29 wt %, from 5 wt % to 28 wt %, from 5 wt % to 27 wt %, from 5 wt % to 26 wt %, from 5 wt % to 25 wt %, from 5 wt % to 20 wt %, from 5 wt % to 18 wt %, from 5 wt % to 15 wt %, from 7 wt % to 20 wt %, 7 wt % to 18 wt %, from 10 wt % to 20 wt %, from 10 wt % to 18 wt %, or from 10 wt % to 15 wt %. In terms of lower limits, the sweetener composition may comprise at least 5 wt % at least one sweetener, e.g., at least 7 wt % or at least 10 wt %. In terms of upper limits, the sweetener composition may comprise less than 30 wt % at least one sweetener, e.g., less than 26 wt %, less than 20 wt %, less than 18 wt % or less than 15 wt %.

In preferred embodiments, the sweetener composition comprises from 80 wt % to 95 wt % pregelatinized starch based on the total weight of the sweetener composition, e.g., from 82 wt % to 93 wt % or from 85 wt % to 90 wt %. In terms of limits, the sweetener composition may comprise at least 80 wt % pregelatinized starch, e.g., at least 82 wt % or at least 85 wt %. In terms of upper limits, the sweetener composition may comprise less than 95 wt % pregelatinized starch, e.g., less than 93 wt % or less than 90 wt %.

In one embodiment, the sweetener composition comprises dry ingredients, e.g., the sweetener composition is a dry powder. In these cases, the (dry) sweetener composition may comprise from 1 wt % to 45 wt % at least one sweetener, e.g., from 3 wt % to 40 wt %, from 3 wt % to 35 wt %, from 5 wt % to 20 wt %, or from 8 wt % to 16 wt %, based on the weight of the dry ingredients. In terms of lower limits, the dry sweetener composition may comprise at least 1 wt % sweetener, e.g., at least 3 wt %, at least 5 wt %, or at least 8 wt %. In terms of upper limits, the dry sweetener composition may comprise less than 45 wt % sweetener, e.g., less than 40 wt %, less than 35 wt %, less than 20 wt %, or less than 16 wt %. The (dry) sweetener composition may comprise from 50 wt % to 99 wt % pregelatinized starch, e.g., from 60 wt % to 95 wt %, from 65 wt % to 90 wt %, from 75 wt % to 92 wt %, or from 77 wt % to 87 wt %. In terms of lower limits, the dry sweetener composition may comprise at least 50 wt % sweetener, e.g., at least 60 wt %, at least 65 wt %, at least 70 wt %, at least 75 wt %, or at least 77 wt %. In terms of upper limits, the dry sweetener composition may comprise less than 99 wt % at least one sweetener, e.g., less than 95 wt %, less than 92 wt %, less than 90 wt %, or less than 87 wt %. In some embodiment discussed herein, weight percentages may be based on the weight of the dry ingredients, including the drying agent. In some embodiment discussed herein, weight percentages may be based on the weight of the dry ingredients, not including the drying agent.

In one embodiment, the sweetener composition comprises a solvent or carrier (in addition to the sweetener and the pregelatinized starch). For example the sweetener composition may be dissolved in the solvent. For example, the sweetener composition may comprise water, glycerol, ethanol, or combinations thereof. Preferably, the sweetener composition may comprise and/or may be prepared using glycerol and/or ethanol as a solvent. In one embodiment, the sweetener composition (solvent included) may comprise from 1 wt % to 45 wt % at least one sweetener, e.g., from 3 wt % to 40 wt %, from 5 wt % to 35 wt %, from 5 wt % to 20 wt %, from 5 wt % to 15 wt %, or from 7 wt % to 13 wt %, based on the weight of the dissolved sweetener composition. In terms of lower limits, the sweetener composition (solvent included) may comprise at least 1 wt % sweetener, e.g., at least 3 wt %, at least 5 wt %, or at least 7 wt %. In terms of upper limits, the sweetener composition (solvent included) may comprise less than 45 wt % sweetener, e.g., less than 40 wt %, less than 35 wt %, less than 20 wt %, less than 15 wt %, or less than 13 wt %. The sweetener composition (solvent included) may comprise from 35 wt % to 99 wt % pregelatinized starch, e.g., from 40 wt % to 95 wt %, from 50 wt % to 85 wt %, from 60 wt % to 80 wt %, from 55 wt % to 75 wt %, or from 63 wt % to 75 wt %. In terms of lower limits, the sweetener composition (solvent included) may comprise at least 35 wt % sweetener, e.g., at least 40 wt %, at least 50 wt %, at least 55 wt %, at least 60 wt %, or at least 63 wt %. In terms of upper limits, the sweetener composition (solvent included) may comprise less than 99 wt % sweetener, e.g., less than 95 wt %, less than 85 wt %, less than 80 wt %, or less than 75 wt %.

In one embodiment, as noted above, some of the at least one sweetener is absorbed into the pregelatinized starch. The pregelatinized starch comprises a plurality of pores and/or capillaries. In a preferred embodiment, the at least one sweetener is disposed in at least one of these pores and/or capillaries. Exemplary sweetener composition production methods are discussed below.

In another embodiment, the present invention is to a method of controlling the release rate of taste sensations associated with the sweetener. The taste sensations may be for example the sweetness provided by the at least one sweetener. In these embodiments, the at least one sweetener is a component of a sweetener composition, as discussed herein. The method comprises the step of contacting, e.g., admixing, the at least one sweetener, e.g., the at least one sweetener in the sweetener composition, with a pregelatinized starch (as discussed herein) to form the release controlled sweetener composition. The release controlled sweetener composition has a prolonged release rate, as compared to a similar sweetener composition that does not include the pregelatinized starch.

In another embodiment, the present invention is to a method of controlling the release rate of sweetener and/or the taste sensations associated with at least one sweetener from a consumable product composition. The consumable product composition may comprise at least one sweetener and a consumable product. The method comprises the step of combining at least one sweetener, a pregelatinized starch (as discussed herein), and the consumable product to form a released controlled consumer product composition. In some embodiments, the release rate of the at least one sweetener is controlled such that the above-discussed release rates are achieved. In preferred embodiments, the at least one sweetener and the pregelatinized starch are combined to form a sweetener composition. This sweetener composition may then be combined with the consumable product to form the consumable product composition.

In another embodiment, the present invention is to a method for decreasing the release rate of at least one sweetener from a consumable product composition. The consumable product composition comprises at least one sweetener and a consumable product and has an initial release rate of sweetener from the consumable product composition. The method comprises the step of adding to the consumer product composition a pregelatinized starch (as discussed herein) in an amount effective to decrease the release rate of at least one sweetener from the consumable product to final release rate. In these embodiments, the addition of the pregelatinized starch to the at least one sweetener surprisingly and unexpectedly decreases the release rate of the at least one sweetener. In preferred embodiments, the addition of the pregelatinized starch to the at least one sweetener provides for a final release rate similar to the release rates discussed above.

In another embodiment, the invention is to a consumable product composition. The consumable product composition comprises a consumable product, at least one sweetener, and a pregelatinized starch (as discussed herein). The pregelatinized starch is present in an amount effective to control the release rate of the at least one sweetener from the consumable product. Preferably, the consumable product composition comprises the sweetener composition of the invention and a consumable product.

In one embodiment, the sweetener composition has a pure taste, high sweetness and intensity, an excellent temperature, pH stability, excellent storage and solubility properties and/or taste-enhancing effects and synergies when combined other sweetening compounds. In one embodiment, the sweetener composition further comprises a sweetness enhancer. Sweetness enhancers that are derived from natural products are preferred options because these sweetness enhancers provide for reductions in the level of conventional caloric sweeteners that may be present. In a preferred embodiment, the sweetener composition is substantially free from off tastes, e.g., metallic tastes, acidic off-tastes, astringent off-tastes, throat-burning off-tastes, or liquorice off-tastes, or combinations thereof. In one embodiment, the sweetener composition is free of one, some, or all of these off tastes.

As used herein, the term “enhance” means to have an effect on a particular flavor sensation in a sweetener composition or in a consumable product composition or other products placed in the oral cavity. As a result of the enhancement, a more pronounced (stronger, enhanced) taste or intensity is achieved.

As used herein, the term “sweetness enhancer(s)” means any compound capable of enhancing or intensifying the sweet taste (or the perception thereof) of sweetener compositions or consumable product compositions containing sweetener compositions. The term “sweetness enhancer” is synonymous to the terms “sweet taste potentiator,” “sweetness potentiator,” and “sweetness intensifier.”

As used herein, the term “high intensity sweetener(s)” means any sweetener, which may in raw, extracted, purified, or any other from, singularly or in combination thereof have a sweetness potency greater than sucrose (common table sugar) yet have comparatively less calories.

### Sweetener

The at least one sweetener, e.g., a first sweetener, or a first and a second sweetener employed in the present invention may vary widely. For example, the sweetener may be an artificial sweetener, a natural sweetener, a sugar alcohol (or polyol) and/or a sugar sweetener (or carbohydrates). Preferably, the sweetener is an artificial sweetener. In preferred embodiments, the sweetener comprises acesulfame K. In one embodiment, the sweetener comprises sucrose. In one embodiment the at least one sweetener comprises a third sweetener, e.g., aspartame.

Exemplary at least one sweeteners include but are not limited to abiziasaponin, abrusosides, in particular abrusoside A, abrusoside B, abrusoside C, abrusoside D, acesulfame potassium, advantame, albiziasaponin, alitame, aspartame, superaspartame, bayunosides, in particular bayunoside 1, bayunoside 2, brazzein, bryoside, bryonoside, bryonodulcoside, carnosifloside, carrelame, curculin, cyanin, chlorogenic acid, cyclamates and its salts, cyclocaryoside I, dihydroquercetin-3-acetate, dihydroflavenol, dulcoside, gaudichaudioside, glycyrrhizin, glycyrrhetin acid, gypenoside, hematoxylin, isomogrosides, in particular iso-mogroside V, lugduname, magap, mabinlins, micraculin, mogrosides (lo han guo), in particular mogroside IV and mogroside V, monatin and its derivatives, monellin, mukurozioside, naringin dihydrochalcone (NarDHC), neohesperidin dihydrochalcone (NDHC), neotame, osladin, pentadin, periandrin I-V, perillartine, D-phenylalanine, phlomisosides, in particular phlomisoside 1, phlomisoside 2, phlomisoside 3, phlomisoside 4, phloridzin, phyllodulcin, polpodiosides, polypodoside A, pterocaryosides, rebaudiosides, in particular rebaudioside A, rebaudioside B, rebaudioside C, rebaudioside D, rebaudioside F, rebaudioside G, rebaudioside H), rubusosides, saccharin and its salts and derivatives, scandenoside, selligueanin A, siamenosides, in particular siamenoside I, stevia, steviolbioside, stevioside and other steviol glycosides, strogines, in particular strogin 1, strogin 2, strogin 4, suavioside A, suavioside B, suavioside G, suavioside H, suavioside I, suavioside J, sucralose, sucronate, sucrooctate, talin, telosmoside A₁₅, thaumatin, in particular thaumatin I and II, trans-anethol, trans-cinnamaldehyde, trilobatin, D-tryptophane, erythritol, galactitol, hydrogenated starch syrups including maltitol and sorbitol syrups, inositols, isomalt, lactitol, maltitol, mannitol, xylitol, arabinose, dextrin, dextrose, fructose, high fructose corn syrup, fructooligosaccharides, fructooligosaccharide syrups, galactose, galactooligosaccharides, glucose, glucose and (hydrogenated) starch syrups/hydrolysates, isomaltulose, lactose, hydrolysed lactose, maltose, mannose, rhamnose, ribose, sucrose, tagatose, trehalose and xylose and combinations thereof. As one example, the at least one sweeteners may be those described by H. Mitchell (H. Mitchell, “Sweeteners and Sugar Alternatives in Food Technology”, Backwell Publishing Ltd, 2006,) and in WO 2009/023975 A2, each of which is incorporated herein by reference in its entirety.

Suitable hydrogenated starch hydrosylates may also be employed as sweeteners. These may include, but are not limited to, those disclosed in U.S. Pat. No. 4,279,931 and various hydrogenated glucose syrups and/or powders which contain sorbitol, maltitol, hydrogenated disaccharides, hydrogenated higher polysaccharides, or combination thereof. Hydrogenated starch hydrosylates are primarily prepared by the controlled catalytic hydrogenation of corn syrups. The resulting hydrogenated starch hydrosylates are mixtures of monomeric, dimeric, and polymeric saccharides.

The above-identified sweeteners are known in the art and are available commercially.

Without being bound by theory, it is believed that these sweeteners possess characteristics that provide for prolonged release rates when these sweeteners are employed in combination with the pregelatinized starch as described above. As one particular example, acesulfame potassium has a particular solubility that allows the acesulfame potassium to load into the pores of the pregelatinized starch. Without being bound by theory, it is postulated that the at least one sweetener of the present invention, when loaded onto the pregelatinized starch using a paraffin medium, may surprisingly and unexpectedly provide for the prolonged release rates.

In preferred embodiments, the sweetener comprises acesulfame potassium and the acesulfame potassium is combined with the pregelatinized starch. One suitable commercial acesulfame potassium product is Sunett® from Nutrinova Nutrition Specialties & Food Ingredients.

In another embodiment, the sweetener composition comprises multiple sweeteners. For example, the at least one sweetener may comprise a first sweetener and one or more, e.g., two or more or three or more, additional sweeteners. In one embodiment, the sweetener composition comprises a first sweetener and a second sweetener (as discussed above) and also at least one additional sweetener. The at least one sweetener, in one embodiment, may be selected from the group consisting of maltitol, sorbitol, and or mannitol. The additional sweetener(s), like the first sweetener, may vary widely. The additional sweetener(s) may be caloric and/or non-caloric. In one embodiment, the additional sweeteners are selected from the sweeteners listed above provided that the additional sweetener(s) is/are different from the first sweetener. Preferably, the at least one additional sweetener(s) are natural sweeteners. In another embodiment, the at least one additional sweetener is an artificial sweetener. The additional sweetener(s) may be present in the sweetener composition in the amounts discussed above with respect to the first sweetener.

In one embodiment, the inventive sweetener compositions further comprise at least one sweetness enhancer, e.g., at least two or at least three. Suitable sweetness enhancers are well known in the art. In one embodiment, the at least one sweetness enhancer may be selected from the group consisting of terpenes (such as sesquiterpenes, diterpenes, and triterpenes), flavonoids, amino acids, proteins, polyols, other known natural sweeteners (such as cinnamaldehydes, selligueains and hematoxylins), secodammarane glycosides, and analogues thereof.

Exemplary sweetness enhancers include stevioside, steviolbioside, rebaudioside A, rebaudioside B, rebaudioside C, rebaudioside D, rebaudioside F, dulcoside A, rubusoside; hernandulcin; pine rosin diperpenoid; mukurozioside; baiyunosdie; phlomisoside, such as phlomisoside I and phlomisodie II; glycyrrhizic acid; periandrins, such as periandrin I, periandrin II, periandrin III, and periandrin IV; osladin; polypodosides, such as polypodoside A and polypodoside B; mogrosides, such as mogroside IV and mogroside V; abrusoside A and abrusosdie B; cyclocariosdies, such as cyclocarioside A and cyclocarioside B; pterocaryoside A and pterocaryoside B; flavonoids, such as phyllodulcin, phloridzin, neoastilbin, and dihydroquercetin acetate; amino acids, such as glycine and monatin; proteins, such as thaumatins (thaumatin I, thaumatin II, thaumatin iii, and thaumatin IV), monellin, mabinlins (mabinlin I and mabinlin II), brazzein, miraculin, and curculin; polyols such as erythritol; cinnamaldehyde; selligueains, such as selligueain A and selligueain B; hematoxylin; and mixtures thereof.

Additional exemplary sweetness enhancers include pine rosin diterpenoids; phloridizin; neoastilbin; dihydroquercetin acetate; glycine; erythritol; cinnamaldehyde; selligueain A; selligueain B; hematoxylin; rebaudioside A; rebaudioside B; rebaudioside C; rebaudioside D; rebaudioside E; dulcoside A; steviolbioside; rubusoside; stevia; stevioside; steviol 13 O-β-D-glycoside; mogroside V; Luo Han Guo; siamenoside; siamenoside I; monatin and salts thereof (monatin SS, RR, RS, SR); curculin; glycyrrhizic acid and its salts; thaumatin I; thaumatin II; thaumatin III; thaumatin IV; monellin; mabinlin I; mabinlin II; brazzein; hernandulcin; phyllodulcin; glycyphyllin; phloridzin; trilobtain; baiyunoside; osladin; polypodoside A; polypodoside B; pterocaryoside A; pterocaryoside B; mukurozioside; mukurozioside lib; phlomisoside I; phlomisoside II; periandrin I; periandrin II; periandrin III; periandrin VI; periandrin V; cyclocarioside A; cyclocarioside B; suavioside A; suavioside B; suavioside G; suavioside H; suavioside I; suavioside J; labdane glycosides; baiyunoside; gaudichaudioside A; mogroside IV; iso-mogroside; bryodulcoside; bryobioside; bryoside; bryonoside; carnosifloside V; carnosifloside VI; scandenoside R6; 1 1-oxomogroside V; abrusoside A; abrusoside B; abrusoside C; abrusoside D; abrusoside E; gypenoside XX; glycyrrhizin; apioglycyrrhizin; araboglycyrrhizin; pentadin; perillaldehyde; rebaudioside F; steviol; 13-[(2-O-(3-O-α-D-glucopyranosyl)-β-D-glucopyranosyl-3-O-β-D-glucopyranosyl-β-D-glucopyranosyl)oxy]kaur-16-en-18-oic acid β-D-glucopyranosyl ester; 13-[(2-O-β-D-glucopyranosyl-3-O-(4-O-α-D-glucopyranosyl)-β-D-glucopyranosyl-β-D-glucopyranosyl)oxy]kaur-16-en-18-oic acid β-D-glucopyranosyl ester; 13-[(3-O-β-D-glucopyranosyl-β-D-glucopyranosyl)oxy]kaur-16-en-18-oic acid β-D-glucopyranosyl ester; 13-hydroxy-kaur-16-en-18-oic acid β-D-glucopyranosyl ester; 13-methyl-16-oxo-17-norkauran-18-oic acid β-D-glucopyranosyl ester; 13-[(2-0-β-D-glucopyranosyl-3-O-β-D-glucopyranosyl-β-D-glucopyranosyl)oxy]kaur-15-en-18-oic acid β-D-glucopyranosyl ester; 13-[(2-O-β-D-glucopyranosyl-3-O-β-D-glucopyranosyl-β-D-glucopyranosyl)oxy]kaur-15-en-18-oic acid; 13-[(2-0-13-D-glucopyranosyl-3-O-β-D-glucopyranosyl]-β-D-glucopyranosyl)oxy]-17-hydroxy-kaur-15-en-18-oic acid β-D-glucopyranosyl ester; 13-[(2-O-β-D-glucopyranosyl-3-O-β-D-glucopyranosyl-β-D-glucopyranosyl)oxy]-16-hydroxy kauran-18-oic acid β-D-glucopyranosyl ester; 13-[(2-O-β-D-glucopyranosyl-3-O-β-D-glucopyranosyl-β-D-glucopyranosyl)oxy]-16-hydroxy kauran-18-oic acid; isosteviol; mogroside IA; mogroside IE; mogroside 11-A; mogroside 11-E; mogroside III; mogroside V; isomogroside V; 1 1-Oxomogroside; mogrol; 1 1-oxomogrol; 1 1-oxomogroside IA; 1-[13-hydroxykaur-16-en-18-oate]β-D-glucopyranuronic acid; 13-[(2-O-β-D-glucopyranosyl β-D-glucopyranosyl)oxy]-17-hydroxy-kaur-15-en-18-oic acid β-D-glucopyranosyl ester; 13-[2-0-β-D-glucopyranosyl-β-D-glucopyranosyl)oxy]kaur-16-en-18-oic acid-(2-O-β-D-glucopyranosyl-β-D-glucopyranosyl)ester (rebaudioside E); 13-[(2-O-α-L-rhamnopyranosyl-3-O-β-D-glucopyranosyl-β-D-glucopyranosyl)oxy]kaur-16-en-18-oic acid-(2-0-β-D-glucopyranosyl-β-D-glucopyranosyl) ester; 13-[(2-O-β-D-glucopyranosyl-3-O-β-D-glucopyranosyl-β-D-glucopyranosyl)oxy]-kaur-16-en-18-oic acid-(2-O-α-L-rhamnopyranosyl-β-D-glucopyranosyl) ester; 13-[(2-O-β-D-glucopyranosyl β-D-glucopyranosyl)oxy]-17-oxo-kaur-15-en-oic acid β-D-glucopyranosl ester; 13-[(2-O-(6-O-β-D-glucopyranosyl)-β-D-glucopyranosyl-β-D-glucopyranosyl)oxy]kaur-16-en-18-oic acid β-D-glucopyranosyl ester; 13-[(2-O-β-D-glucopyranosyl-3-O-β-D-fructofuranosyl-β-D-glucopyranosyl)oxy]kaur-16-en-18-oic acid β-D-glucopyranosyl ester; 13-[(2O-β-D-glucopyranosyl-β-D-glucopyranosyl)oxy]kaur-16-en-18-oic acid-(6-O-β-D-xylopyranosyl-β-D-glucopyranosyl) ester; 13-[(2-O-β-D-glucopyranosyl-β-D-glucopyranosyl)oxy]kaur-16-en-18-oic acid-(4-O-(2-O-α-D-glucopyranosyl)-α-D-glucopyranosyl-D-glucopyranosyl) ester; 13-[(2-O-β-D-glucopyranosyl-3-O-β-D-glucopyranosyl-β-D-glucopyranosyl)oxy]kaur-16-en-18-oic acid-(2-O-6-deoxy-β-D-glucopyranosyl-β-D-glucopyranosyl) ester; 13-[(2-0-β-D-glucopyranosyl-β-D-glucopyranosyl)oxy]kaur-15-en-18-oic acid β-D-glucopyranosyl ester; 13-[(2-O-β-D-glucopyranosyl-3-O-β-D-xylopyranosyl-β-D-glucopyranosyl)oxy]kaur-16-en-18-oic acid β-D-glucopyranosyl ester; 13-[(2-O-β-D-xylopyranosyl-β-D-glucopyranosyl)oxy]kaur-16-en-18-oic acid β-D-glucopyranosyl ester; 13-[(3-O-β-D-glucopyranosyl-β-D-glucopyranosyl)oxy]kaur-16-en-18-oic acid β-D-glucopyranosyl ester; 13-[(2-O-6-deoxy-β-D-glucopyranosyl-3-O-β-D-glucopyranosyl-β-D-glucopyranosyl)oxy]kaur-16-en-18-oic acid β-D-glucopyranosyl ester; 13-[(2-O-6-deoxy β-D-glucopyranosyl-β-D-glucopyranosyl)oxy]kaur-16-en-18-oic acid β-D-glucopyranosyl ester; and mixtures thereof.

Additional exemplary sweetness enhancers include rebaudioside C, rebaudioside F, rebaudioside D, 13-[(2-O-β-D-glucopyranosyl-3-O-β-D-glucopyranosyl]-β-D-glucopyranosyl)oxy]-17-hydroxy-kaur-15-en-18-oic acid β-D-glucopyranosyl ester, 13-[(2-O-(3-O-β-D-glucopyranosyl)-β-D-glucopyranosyl-3-O-β-D-glucopyranosyl-β-D-glucopyranosyl)oxy]kaur-16-en-18-oic acid β-D-glucopyranosyl ester, and Rubusoside. Further for example, the at least one sweetness enhancer is chosen from rebaudioside A, stevioside, rebaudioside D, rebaudioside E, mogroside V, mogroside IV, brazzein, and monatin.

In one embodiment, the at least one sweetness enhancer is present in an amount at or below the sweetness detection threshold level of the at least one sweetness enhancer. In some embodiments, the at least one sweetness enhancer is present in an amount below the sweetness detection threshold level of the at least one sweetness enhancer. The sweetness detection threshold level can be specific for a particular compound. However, generally, in some embodiments, the at least one sweetness enhancer is present in an amount ranging from 0.5 ppm to 1000 ppm. For example, the at least one sweetness enhancer may be present in an amount ranging from 1 ppm to 300 ppm; and at least one sweetness enhancer may be present in an amount ranging from 0.1 ppm to 75 ppm; and at least one sweetness enhancer may be present in an amount ranging from 500 ppm to 3,000 ppm.

As used herein, the terms “sweetness threshold,” “sweetness recognition threshold,” and “sweetness detection threshold” are understood to mean the level at which the lowest known concentration of a certain sweet compound that is perceivable by the human sense of taste and it can vary from person to person. For example, a typical sweetness threshold level for sucrose in water can be 0.5%. Further for example, the at least one sweetness enhancer to be used can be assayed in water at least 25% lower and at least 25% higher than the sucrose detection level of 0.5% in water to determine the sweetness threshold level. A person of skill in the art will be able to select the concentration of the at least one sweetness enhancer so that it may impart an enhanced sweetness to a composition comprising at least one sweetener. For example, a skilled artisan may select a concentration for the at least one sweetness enhancer so that the at least one sweetness enhancer does not impart any perceptible sweetness to a composition that does not comprise at least one sweetener.

In some embodiments the sweetener composition may further comprise a solvent or a carrier. For example, the solvent may allow the sweetener composition to be more easily combined with a consumable product. In preferred embodiments, the dissolved sweetener composition, advantageously, is liquid at fairly low temperatures, e.g., the sweetener compositions do not form a gel at fairly low temperatures. In one embodiment, the dissolved sweetener compositions do not gel or begin to form a gel at temperatures less than 100° C., less than 75° C., less than 50° C., less than 35° C., less than 25° C., or less than 20° C. In one embodiment, the dissolved sweetener compositions may gel or may form a gel at higher temperatures, e.g., temperatures greater than 20° C., greater than 25° C., greater than 35° C., greater than 50° C., greater than 75° C., or greater than 100° C.

In some embodiments, the compounds listed above as sweeteners may also function as sweetness enhancers. Generally speaking, some sweeteners may also function as sweetness enhancers and vice versa. The sweetness enhancer(s) may be present in the sweetener composition in the amounts discussed above with respect to the first sweetener.

The sweetener composition or the consumable product composition of the present invention may contain further additives known to those skilled in the art. These additives include but are not limited to bulking agents, carriers, fibers, flavorings, flavor enhancers, flavor stabilizers, acidulants, anti-caking and free-flow agents. Such additives are for example described by H. Mitchell (H. Mitchell, “Sweeteners and Sugar Alternatives in Food Technology”, Backwell Publishing Ltd, 2006, which is incorporated herein by reference in its entirety).

Flavorings are generally known to behave differently than sweeteners. For example, taste profiles of sweeteners may be less predictable than those of flavorings. As such, as used herein, the sweetener(s) used in the inventive sweetener compositions are distinguished from conventional flavorings.

As used herein, the term “flavorings” may include those flavors known to the skilled person, such as natural and artificial flavors. These flavorings may be chosen from synthetic flavor oils and flavoring aromatics and/or oils, oleoresins and extracts derived from plants, leaves, flowers, fruits, and so forth, and combinations thereof. Nonlimiting representative flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Also useful flavorings are artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavorings include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. Other commonly used flavors include mints such as peppermint, menthol, spearmint, artificial vanilla, cinnamon derivatives, and various fruit flavors. A preferred flavoring is menthol and, in one embodiment, the inventive sweetener composition comprises acesulfame potassium, menthol, and pregelatinized starch. Flavors may also provide breath freshening properties, particularly the mint flavors when used in combination with cooling agents. These flavorings may be used in liquid or solid form and may be used individually or in admixture.

Other useful flavorings include aldehydes and esters such as cinnamyl acetate, cinnamaldehyde, citral diethylacetal, dihydrocarvyl acetate, eugenyl formate, p-methylamisol, and so forth may be used. Generally any flavoring or food additive such as those described in Chemicals Used in Food Processing, publication 1274, pages 63-258, by the National Academy of Sciences, may be used. This publication is incorporated herein by reference.

Further examples of aldehyde flavorings include but are not limited to acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), cherry, grape, strawberry shortcake, and mixtures thereof. These listings of flavorings are merely exemplary and are not meant to limit either the term “flavoring” or the scope of the invention generally. The flavorings may be employed individually or in combinations.

In some embodiments, the flavoring may be employed in either liquid form and/or dried form. When employed in the latter form, suitable drying means such as spray drying the oil may be used. Alternatively, the flavoring may be absorbed onto water soluble materials, such as cellulose, starch, sugar, maltodextrin, gum arabic and so forth or may be encapsulated. The actual techniques for preparing such dried forms are well-known.

In some embodiments, the flavorings may be used in many distinct physical forms well-known in the art to provide an initial burst of flavor and/or a prolonged sensation of flavor. Without being limited thereto, such physical forms include free forms, such as spray dried, powdered, beaded forms, encapsulated forms, and mixtures thereof.

U.S. Pat. Nos. 6,627,233; 5,698,181; 5,688,491; 5,451,404; and 5,009,893 are hereby incorporated by reference in their entireties, including, but not limited to, the flavorings, sweeteners, sweetness enhancers, additional flavoring ingredients, solutions, consumables, consumable compositions, and formulations that are disclosed therein.

Preferably, a 1 gram portion of the sweetener composition provides sweetness comparable to one to three teaspoons of granulated sugar, preferably comparable to two teaspoons of granulated sugar. Preferably, one gram of the sweetener composition contains less calories and carbohydrates than about 1 gram of granulated sugar, e.g., less than about 0.5 grams of granulated sugar.

For example, the compositions may contain sweetness comparable to that of granulated sugar (sucrose), and therefore can be used “spoon-for-spoon” or “cup-for-cup” in place of sugar.

The sweetener composition of the invention may take any suitable form including, but not limited to, an amorphous solid, a crystal, a powder, a tablet, a liquid, a cube, a glace or coating, a granulated product, an encapsulated form abound to or coated on to carriers/particles, wet or dried, or combinations thereof. In a preferred embodiment, the sweetener composition is a liquid at ambient conditions. In another embodiment, the sweetener composition is a solid at ambient conditions.

In one embodiment, the sweetener composition can be provided in pre-portioned packets or ready-to-use formulations, which include the sweetener composition. For example, in one embodiment in which a sweetener other than sucrose is employed, a single serving packet formulation (usually about a 1 gram portion) can provide sweetness comparable to that contained in two teaspoons of granulated sugar (sucrose). It is known in the art that a “teaspoon” of sucrose contains approximately 4 grams of sucrose.

In another embodiment in which a sweetener other than sucrose is used, a volume of a ready-to-use formulation can provide sweetness comparable to the same volume of granulated sugar. Preferably, a single serving packet of the composition comprising the compound of formula (I) as defined above or a derivative or a stereoisomer or a salt or a hydrate thereof (e.g., 1 gram) can provide sweetness comparable to about 0.9 to about 9.0 grams of granulated sugar (sucrose). In another embodiment, 1 gram of the sweetener composition contains less calories and carbohydrates than about 1 gram of granulated sugar.

As used herein, the term “about” encompasses the range of experimental error that occurs in any measurement. Unless otherwise stated, all measurement numbers are presumed to have the word “about” in front of them if the word “about” is not expressly used.

As used herein, the phrase “sweetness comparable” means that an experienced sensory evaluator, on average, will determine that the sweetness presented in a first composition is within a range of 80% to 120% of the sweetness presented in a second composition. The phrase “a sweetness comparable” relates to a determination ascertained by four or more experienced sensor evaluators in a sweetness matching test (designated hereinafter as “taste and spit assay”), as discussed below. Thus, for instance, 100 mg/ml of a sweetener composition comprising the compound of formula (I) provides “sweetness comparable” to 100 mg/ml of sucrose if the sweetener composition of the invention has a sweetness falling within the range of sweetness presented in 80-120 mg/ml of sucrose.

The sweetness properties of the sweetener composition, in some embodiments, can be identified by an in vitro in cell based assay as described in EP 1 865 316 B1, which is incorporated herein by reference, or by field effector transistor technology of e.g. Alpha MOS.

The taste of the sweetener composition with regard to sweetness and/or sweetness enhancing properties, in other embodiments, may be assessed in vivo by using a panel of trained sensory evaluators experienced in the sweet taste estimation procedure, e.g. in a taste and spit assay.

In these cases, panelists are asked to take a sample of the composition to be assessed, e.g., the sweetener composition, into the mouth and after some time allowed for taste perception to spit the sample out completely. Subsequently, the panelists are asked to rinse their mouth well with water or black tea to reduce any potential carry over effects. The tasting of a sample can be repeated if required.

In a first descriptive test (qualitative assessment for sweetness) the panelists are asked to taste the quality of single samples (maximum 3 subsequent samples. The individuals of the taste panel are asked to answer the following questions with regard to the quality of taste: 1) does the sample taste sweet?, 2) is there another taste detectable (bitter, sour, salty, umami)?, 3) is there an off- or aftertaste?, 4) is there anything else remarkable about the perception of the sample?

In the next step (assessment of sweetness enhancing, e.g., fructose enhancing, features) the panelists are asked to answer questions in a pairwise comparison test to determine the enhancement of sweet taste of the test substance with fructose relative to fructose only. Again the panelists are given samples. Two samples are prepared for direct comparison regarding sweetness. One sample contains fructose in a solvent and the other sample additionally contains the test substance. Designation of the samples with A and B is randomized and is decoded after the taste procedure. The questions to be answered are: 1) does one sample taste sweeter than the other?, 2) if so, which one?, 3) are there any other differences in the taste between the two samples? The result of the taste and spit assay is a qualitative evaluation of the differences between the two samples.

In another embodiment, the sweetness and/or sweetness enhancing properties of the inventive sweetener composition, when dissolved in water, correspond to a particular degree Brix, a well-known measurement of sugar content in an aqueous solution. In some embodiments, for example, when 5 grams of sweetener composition are dissolved in 95 grams of water, the resultant solution has a sweetness that corresponds to a degrees Brix value ranging from 1 to 1000, e.g., from 5 to 500 or from 5 to 100.

In one embodiment of the invention, the sweetener composition of the invention is liquid at ambient conditions. In another embodiment of the invention, the sweetener composition of the invention is solid at ambient conditions.

In one embodiment of the invention, the sweetener composition of the invention comprises homogeneous particles comprising the sweetener and the pregelatinized starch.

### Pregelatinized Starch

The pregelatinized starch may vary widely and many pregelatinized starches are known in the art. Examples include the pregelatinized starches disclosed in U.S. Pat. No. 5,919,486, WO 89/04842, WO 2007/110645, and WO 2009/103514. The shape of the pregelatinized starch particles may vary widely. For example, the pregelatinized starch may be granular. In some cases, small particles sizes and/or irregular particle shapes may correlate with a high specific surface area, which in turn correlates with a high loading capacity. Thus, in some embodiments, small particles with a high specific surface area may be used for the purpose of supporting the sweetener(s).

In one embodiment, the starch particles have a specific surface area, e.g., a BET specific surface area, ranging from 0.05 m²/g to 1 m²/g, e.g., from 0.05 m²/g to 0.75 m²/g, from 0.05 m²/g to 0.5 m²/g or from 0.05 m²/g to 0.4 m²/g. In terms of lower limits, the starch particles may have a specific surface area of at least 0.05 m²/g, e.g., at least 0.1 m²/g, at least 0.2 m²/g, at least 0.3 m²/g, at least 0.4 m²/g, or at least 0.5 m²/g. In terms of upper limits, the starch particles may have a specific surface area of less than 1 m²/g, e.g., less than 0.9 m²/g or less than 0.5 m²/g. In one embodiment, the starch particles have a specific surface area as low as 0.5 m²/g or less, e.g., 0.4 m²/g or less, less than 0.3 m²/g.

The ranges and limits discussed herein may be applicable to the pregelatinized starches of the present invention, whether the pregelatinized starches are granular, non-granular, e.g., flaked, other shapes, or combinations thereof.

In one embodiment, the inventive sweetener compositions comprise both granular pregelatinized starch and flake pregelatinized starch.

In some embodiments, the starch may be non-granular. Preferably, the pregelatinized starch may be in the form of flakes, e.g. the pregelatinized starch may have a flake or honeycomb structure. In one of these embodiments, the flake-shaped starch particles have a particle size ranging from 50 μm to 500 μm, e.g., from 100 μm to 375 μm, as determined by sieve analysis. In one embodiment, the flake-shaped starch particles are relatively large particles, and the BET specific surface area is as low as 0.5 m²/g or less, e.g., 0.4 m²/g or less, less than 0.3 m²/g. In terms of ranges the flake-shaped particles may have a specific surface area ranging from 0.05 m²/g to 0.5 m²/g, e.g., from 0.05 m²/g to 0.4 m²/g. In one embodiment, the inventive sweetener compositions comprise both granular pregelatinized starch and flake pregelatinized starch.

In some embodiments, the starch may be granular. In one of these embodiments, the granular starch particles have a particle size ranging from 50 μm to 500 μm, e.g., from 100 μm to 375 μm, as determined by sieve analysis. In one embodiment, the granular starch particles are relatively large particles, and the BET specific surface area is as low as 0.5 m²/g or less, e.g., 0.4 m²/g or less, less than 0.3 m²/g. In terms of ranges the granular particles may have a specific surface area ranging from 0.05 m²/g to 0.5 m²/g, e.g., from 0.05 m²/g to 0.4 m²/g.

In one embodiment, the pregelatinized starch, whether it is in granular or flake form, has a high porosity. The pores of the pregelatinized starch may have the dimensions discussed herein. In one embodiment, the pregelatinized starch, whether it is in granular or flake form, has a loading capacity greater than 10%, e.g., greater than 20%, greater than 30%, greater than 40%, greater than 50%, greater than 60%, greater than 70%, greater than 80%, or greater than 90%. In terms of upper limits, the pregelatinized starch, whether it is in granular or flake form, has a loading capacity less than 90%, e.g., less than 80%, less than 70%, less than 60%, less than 50%, or less than 40%. The loading capacity may range from 10% to 90%, e.g., from 20% to 80%, from 30% to 70%, or from 40% to 60%.

In one embodiment, the pregelatinized starch may have a density, e.g., a tapped density. For example the density of the pregelatinized starch may range from 100 g/l to 750 g/l, e.g., from 200 g/l to 550 g/l, or from 350 g/l to 400 g/l. In terms of upper limits, the density of the pregelatinized starch may be less than 750 g/l, e.g., less than 550 g/l or less than 400 g/l. In terms of lower limits, the density of the pregelatinized starch may be at least 100 g/l, e.g., at least 200 g/l or at least 350 g/l.

Without being bound by theory, the pregelatinized starches utilized in the present invention possess features and properties that are distinct from typical starches and/or bulking agents. Because conventional bulking agents lack the features and properties of the pregelatinized starches, these conventional bulking agents, when combined with sweeteners, would not be expected to provide the surprising and unexpected release rates demonstrated by the sweetener compositions of the present invention.

The term “pregelatinized starch”, when used herein, means a starch that has been chemically and/or mechanically and/or thermally treated in the presence of water to decrease the number and size of crystalline regions and increase the randomness in the general structure, and has been subsequently dried. Typically, the structural changes induced by gelatinization are manifested in the loss of birefringence and/or Maltese crosses in polarized light. The pregelatinized starches may or may not have lost their granular structure and are substantially soluble in cold water without cooking. In accordance with the present invention, “pregelatinized starches” may also be chemically modified to impart desirable properties, such as flowability, hydrophobicity and the like. Preferably, the pregelatinized starch used in the present invention is not chemically modified. Furthermore, the term “pregelatinized starch” may also include partially pregelatinized starch (PPS), which contains soluble (gelatinized) and insoluble fractions. Preferably, the pregelatinized starch used in the present invention is completely or predominantly pregelatinized, e.g., with less than 90%, e.g., less than 80%, less than 70%, less than 60%, less than 50%, less than 40%, less than 30%, less than 20%, less than 10%, less than 5%, less than 2%, or less than 1% by weight, of crystalline regions. In one embodiment, the pregelatinized starches of the present invention exclude hydrogenated starch hydrosylates, which are commonly known in the art to be sweeteners. Hydrogenated starch hydrosylates are known to have higher amounts of crystalline regions.

In accordance with the present invention, the term “chemically modified starches” or “chemical modification” of starches includes, but is not limited to, crosslinked starches, starches modified with blocking groups to inhibit retrogradation, starches modified by the addition of lipophilic groups, acetylated starches, hydroxyethylated and hydroxypropylated starches, inorganically esterified starches, cationic, anionic and oxidized starches, zwitterionic starches, starches modified by enzymes, and combinations thereof.

Suitable pregelatinized starches for use herein can be derived from any native source, wherein native relates to the fact that said starch is found in nature. Typical sources for the starches are cereals, tubers, roots, legumes, fruit starches and hybrid starches. Suitable sources include, but are not limited to, corn, pea, potato, sweet potato, sorghum, banana, barley, wheat, rice, sago, amaranth, tapioca, arrowroot, canna, and low amylose (containing no more than about 10% by weight amylose, preferably no more than 5%) or high amylose (containing at least about 40% by weight amylose) varieties thereof. Also suitable are starches derived from a genetically modified starch crop. A preferred starch for use herein has an amylose content below 40%, including waxy corn starch with less than 1% amylose content. Particularly preferred starches include rice, wheat, tapioca, corn, and potato starches, in particular corn (maize) starch. In one embodiment, the pregelatinized starch is derived from a source other than potatoes, e.g., the pregelatinized starch is not a potato starch.

A “granular shape” is intended to mean a roughly spheroid or ellipsoid shape and includes spherical particles that have indentations in one or more portions thereof, such as the spherical starch particles produced by a conventional spray-drying process. A “non-granular starch material”, as used herein, refers to a starch material consisting of particles that do not have a granular shape. A “flake-shaped” or a “flaked” starch particle, when used herein, is a particle that does not have a granular structure and has a heterogeneous shape in the form of irregular flat or thick plates or sheets. Typically, roll-drying or drum-drying processes generate such flake-shaped starch particles. Other processes, however, may be employed to provide the flake-shaped particles.

In preferred embodiments, at least 80 wt %, e.g., at least 90 wt %, at least 95 wt %, or 100 wt % by weight of the starch particles have a particle size of between 50 μm and 500 μm, e.g., from 125 μm and 350 μm, between 125 μm and 325 μm, or between 125 μm and 300 μm. A particularly preferred pregelatinized, non-granular starch material has a particle size of 100 μm to 375 μm for at least 50% by weight, preferably 80% by weight, of the starch particles, and a BET specific surface area of less than or equal to 0.5 m²/g, preferably less than or equal to 0.4 m²/g.

In one embodiment, the pregelatinized starch has a calorie content similar to that of sucrose.

A preferred commercial pregelatinized starch is Starrier R™ and similar products from Cargill. Similar suitable products may be provided from sources other than Cargill.

In one embodiment, the pregelatinized, starch, whether in granular or flake form, may include minor amounts of one or more additives, preferably in a total amount of no more than 10% by weight, more preferably no more than 5% by weight, most preferably 0% to 1% by weight, based on the total weight of the pregelatinized starch. These optionally present additives may be added to the starch slurry or paste used for preparing the pregelatinized starch material of the present invention. Examples of additive include, but are not limited to, processing aids, such as agents for enhancing the formation of bubbles, surfactants and emulsifiers, and other ingredient, such as salts, sugars, fat, gums and hydrocolloids. In some embodiments, the additives included in the pregelatinized starch material may also be substances that have been added to the formed pregelatinized starch material to provide it with desirable properties. An example thereof is a surface modifying agent, which changes the absorption properties of the starch to improve, for example, the absorption of hydrophobic ingredients like oils and fats.

Preferably the pregelatinized starch material is produced by a roll-drying or drum-drying process. Roll-drying as well as drum-drying involve the heating of an aqueous starch slurry or paste to gelatinize the starch and to instantaneously remove the moisture. The aqueous starch slurry or paste may be first heated and subsequently dried or, more preferably, the starch may be simultaneously gelatinized by heating and dried using a commercially available drum-dryer or roll-dryer apparatus. As used herein, the term “roll-drying” refers to a process where an aqueous starch slurry or paste is cooked or partially cooked and passed on heated rolls (sometimes also referred to as “drums”) for drying or, preferably, a process where the aqueous starch slurry or paste is simultaneously cooked and dried on heated rolls. The term “drum-drying”, when used herein, refers to a process very similar to the roll-drying process, except that a thicker coating of the starch slurry or paste is applied to heated drums.

In one embodiment, a process for preparing the pregelatinized starch material described hereinabove starts with mixing starch (generally in the form of a starch powder) and water to prepare an aqueous starch slurry or paste having a certain solids content. A starch “slurry or paste” may also include high-viscosity starch preparations, such as a moist filter cake. Suitable starches are as defined above. The starch content typically ranges from 20 wt % to 45 wt % by weight, e.g., from 25 wt % to 40 wt %% by weight, or from 32 wt % to 40 wt %.

The prepared aqueous starch slurry or cake may then be applied onto heated, rotating rolls or drums of a roll-dryer or drum-dryer, conveniently by means of application drums or feed rolls, to simultaneously gelatinize and dry the aqueous starch slurry or paste. After one rotation, the obtained dried starch film is removed from the rolls or drums by a scrapping mechanism, such as a knife blade, to obtain a starch material, which is then subjected to grinding or milling, for example in a rotor beater mill or cutting mill. Finally, the ground (milled) starch material is sieved using one or several sieves of different mesh sizes, as known in the art, to obtain the desired sieve fraction of the pregelatinized, non-granular starch material.

Suitable roll-dryers and drum-driers for preparing the pregelatinized, non-granular starch material of the present invention are commercially available, for example from GMF-Gouda (The Netherlands). Typically, they are designed as indirect dryers, where heat is transferred by pressurized stream to the inside (metal) drum wall, which in turn transfers the heat to the aqueous starch slurry or paste on the other side of the wall. While the basic construction is relatively simple, there are numerous configurations commercially available, which differ in the arrangement and number of drums and feed rolls, the type of scrapping mechanism, etc. Factors, such as the composition of the aqueous slurry or paste, the roll or drum temperature, and the drum or roll speed (which determines the residence time), will have an effect on the physical and chemical properties of the final pregelatinized, non-granular starch material. It is within the scope of the invention to or adjust process parameters to obtain a pregelatinized starch material having desirable properties. For example, different types of starches are known to have varying gelatinization temperatures and thus one or more of the above parameters may be adjusted and optimized to achieve a satisfactory result. Such optimizations are well within the normal capabilities of a person skilled in the art of drum-dried or roll-dried pregelatinized starches.

The rolls or drums are typically heated to have a surface temperature in the range from 120° C. to 200° C., e.g., from 140° C. to 190° C., or from 150° C. to 180° C. The rolls or drums are normally operated at a speed or rotation rate of 5 to 18 rpm, e.g., 5 to 15 rpm, or 8 to 13 rpm.

One or more additional constituents (additives) may be admixed to the aqueous starch slurry or paste including, but not limited to, processing aids, such as bubble-forming agents, surfactants and emulsifiers, and other substances, such as salts, sugars, fat, gums, and hydrocolloids to improve certain properties. For example, the starch slurry or paste applied to the heated rolls or drums gets transformed into a continuous phase of melted starch that includes variable amounts of air bubbles. In order to obtain a pregelatinized starch material with an increased absorption capacity, conditions might be chosen to result in a relatively low bulk density, for example, by adding specific processing aids to the aqueous starch slurry or paste to increase formation of bubbles.

Furthermore, it is also within the scope of the present invention, that the obtained roll-dried or drum-dried, pregelatinized, non-granular starch material is additionally treated with a surface modifying agent to change the absorption properties of the starch. A hydrophobic agent, for example, will further improve the absorption capacity for hydrophobic liquid components, like oils and fats.

Exemplary methods to assess the physical characteristics of the pregelatinized starch follow.

(1) Particle Size Distribution

The particle size distribution of starch samples may be determined by a sieve analysis using sieves with different openings. The respective sieve fractions on the sieves were weighted and divided by the total weight of the starch sample to give a percentage retained on each sieve.

(2) Particle Shape

The particle shape of starch samples was observed by scanning electronic microscopy at magnifications of 100 to 750×, as known in the art.

(3) Bet Specific Surface Area

The specific surface area of starch samples was measured by nitrogen absorption in a Gemini II 2370 Surface Area Analyzer (Micromeritrics NV/SA, Brussels, Belgium). The multi-point (11 points by convention) BET-method (Bruauner, Emmett and Teller, J. Am. Chem. Soc. 60:309-319 (1938)) was used to determine the total available surface area.

### Preparation Methods

In one embodiment, the present invention relates to a process for preparing the sweetener composition. The inventive method comprises the step of applying one or more sweeteners to the pregelatinized starch. In one embodiment, the inventive method comprises the step of combining, e.g., admixing, the at least one sweetener with a pregelatinized starch to form a release controlled sweetener composition.

For loading the pregelatinized starch material with sweetener(s), the starch material may be placed in a vessel supporting mechanical mixing and preferable capable of being sealed. Suitable mixing devices are, for example, a paddle mixer, a ribbon blender, a V-blender, or a plough blade mixer. The sweetener(s) may then be supplied, for example poured, pumped or, preferably, sprayed via a nozzle, into the vessel and applied onto the agitated pregelatinized starch material. In some embodiments, the sweetener is supplied in the form of a sweetener mixture comprising the sweetener and a carrier. Spraying via a nozzle is advantageously used because the nozzle leads to the formation of small droplets that are more easily absorbed by the pregelatinized starch. Loading from the gas phase or under supercritical conditions is also possible. The mixing may be continued until an even distribution of the sweetener into and/or onto the pregelatinized starch is obtained. The time required for spraying or pumping is dependent upon the addition level of the sweetener(s) onto the pregelatinized starch and the time required to ensure complete absorption to form a free flowing powder.

In one embodiment, the process for preparing the sweetener composition employs the step of preparing a dissolved sweetener mixture. The dissolved sweetener mixture comprises at least one sweetener and at least one solvent. For example the dissolved mixture may be formed by admixing the sweetener and the solvent. Preferably, acesulfame-K and/or sucralose are admixed with water to form the dissolved mixture. Of course, other suitable sweeteners and solvents may be utilized. Other exemplary solvents include glycerine and ethanol.

In one embodiment, the step of combining the pregelatinized starch with the sweetener is achieved by admixing the dissolved mixture and the pregelatinized starch. The sweetener/pregelatinized starch combination may then be dried using a drying agent, e.g., magnesium carbonate, to obtain the sweetener composition.

As mentioned above, in one embodiment, the sweetener compositions of the present invention are formed by contacting the pregelatinized starch with a sweetener mixture comprising the at least one sweetener and a carrier. Preferably, the carrier is glycerol, however ever other suitable carriers may be employed. Without being bound by theory, the pregelatinized starch has a plurality of pores and capillaries. Upon contacting the sweetener mixture with these pores and/or capillaries, the at least one sweetener is distributed therein, as discussed herein. The at least one sweetener that is disposed in the pores and/or capillaries may then be released, e.g., released at a prolonged rate, as pressure is applied to the sweetener composition or to the consumable product that comprises the composition, e.g., via chewing. Some conventional compositions may merely include sweeteners and pregelatinized starches as ingredients. These conventional compositions do not, however, demonstrate the sweetener/particle/pore configuration of the present invention.

Another suitable method for loading sweetener(s) onto the pregelatinized starch material may be a fluidized-bed loading process. In such a process, the pregelatinized starch material is fluidized by forcing air or another gas upward through a bed of starch particles. The sweetener(s) are then sprayed via a nozzle onto the fluidized starch particles to yield a sweetener-loaded starch material of evenly loaded starch particles. Again, the sweeteners may be supplied in the form of a sweetener mixture comprising the sweetener and a carrier.

A further suitable loading method for use herein comprises the steps of suspending the pregelatinized starch carrier material in the sweetener(s), e.g., in a sweetener mixture, followed by separating the powdered sweetener-loaded starch material from the liquid components by conventional separation methods, such as filtration or centrifugation.

Depending on the type of sweetener(s) to be loaded, the sweetener(s) may be heated or cooled. In case of high viscous liquid components, for example, it might be favorable to heat the sweetener(s) to decrease the viscosity and facilitate the loading process. In case of temperature-sensitive sweetener(s), cooling might be desired or required. Means for cooling or heating, such as a cooled or heated blender, are well-known to a person skilled in the art.

In accordance with the present invention, the pregelatinized starch may be pre-treated before loading with an inert gas to remove, for instance, oxygen. The pregelatinized starch may also be vacuum-treated before loading to increase the absorption capacity. Further, when sensitive liquids are to be loaded, the loading operation might be carried out under an inert gas atmosphere, for example under a nitrogen atmosphere to protect against loss of quality by oxidation.

After having loaded the pregelatinized starch material with one or more sweetener(s), further processing steps may optionally follow. For example, flowing or anti-caking agents may be added to the sweetener-loaded starch material, such as tricalcium phosphate, silica, silicates and/or stearates, to increase flowability. The powdered sweetener-loaded starch material of the present invention may also be provided with a coat and/or further encapsulated by any suitable encapsulating or coating materials, such as maltodextrins, starches, modified starches, dextrins, oils, fats, waxes, hydrocolloids, proteins, as known in the art.

The inventive sweetener compositions may further comprise celluloses. As used herein, the term “cellulose” refers to any cellulosic material (other than the pregelatinized starches described herein) known to the skilled person. As indicated above, the pregelatinized starches of utilized in the present invention are different from conventional starches or celluloses and possess particular characteristics that provide for some of the features of the inventive sweetener composition. These characteristics are not present in all starches or cellulosic materials. Thus, it is not expected that conventional starches and/or celluloses would provide for the inventive features demonstrated by the present invention.

In typical embodiments, the cellulose includes polysaccharides having linear chains of at least several hundred beta-linked D-glucose units. When obtained from commercial sources, for example, the cellulose may exist as a powder. Further, in some embodiments, the cellulose is insoluble or substantially insoluble in water. In other embodiments, when incorporated into a consumable product, the cellulose preferably will not detract substantially from the overall product dissolution. Chemically modified celluloses can be employed in the compositions of the invention provided the modifications do not result in water soluble material. The cellulose may have any particle size (or particle size distribution) that is suitable for use in a sweetener composition. For example, in some embodiments, the size of the cellulose particles may range from about 1 micron to about 400 microns, e.g., from about 3 microns to about 300 microns, from about 5 microns to about 200 microns, or from about 6 microns to about 100 microns. In some embodiments, the insoluble cellulose is a cellulose that if used in amounts exceeding 1% in an aqueous medium can lead to significant viscosity change.

### Consumable Products

The inventive sweetener compositions can be added to any consumable products including but not limited to dry/powdered beverage mixtures, gums, dental products, pharmaceutical products and animal feed or animal food. The inventive sweetener compositions as described above can be added to consumable products that are produced in a household or on a small scale.

Thus, in another aspect, the invention relates to a consumable product composition comprising:

(a) a consumable product; and

(b) a sweetener composition of the invention as defined above.

Preferably, the consumable comprises at least one, e.g., at least two, additional sweeteners and/or sweetness enhancers, as described above.

Preferably, the sweetener composition of the invention are present in the consumable in an amount effective to increase a sweetness level of the consumable product, e.g., as compared to the consumable product without the sweetener composition.

In one embodiment of the invention, the consumable product composition comprises the sweetener composition in an amount ranging from 0.1 wt % to 10 wt %, e.g., from 1 wt % to 10 wt %, or from 1 wt % to 5 wt %.

In one embodiment, the consumable product comprises smaller amounts of the sweetener composition. For example, the consumable product comprises from 0.05 wt % to 10 wt %, sweetener composition, based on the weight of the consumable product, e.g., from 0.1 wt % to 8 wt %, from 0.15 wt % to 5 wt %, from 0.05 wt % to 1 wt %, from 0.1 wt % to 0.5 wt %, from 0.5 wt % to 5 wt %, from 1 wt % to 2.5 wt %, or from 0.18 wt % to 2.2 wt %. In terms of lower limits, the consumable product may comprise at least 0.05 wt % sweetener composition, e.g., at least 0.1 wt %, at least 0.15 wt %, at least 0.18 wt %, at least 0.5 wt %, or at least 1 wt %. In terms of upper limits, the consumable product may comprise less than 10 wt % sweetener composition, e.g., less than 8 wt %, less than 5 wt %, less than 2.5 wt %, less than 2.2 wt %, or less than 1 wt %.

The concentration of the sweetener and the pregelatinized starch in the consumable product may vary widely. In one embodiment of the invention, the consumable product composition comprises the sweetener in a concentration from 0.1 wt % to 5 wt %, e.g., from 0.5 wt % to 2 wt %, or from 0.5 wt % to 1.5 wt %. In one embodiment of the invention, the consumable comprises the pregelatinized starch in an amount ranging from 0.1 wt % to 9.5 wt %, e.g., from 5 wt % to 9.5 wt %, e.g., from 8 wt % to 9.5 wt %.

In one embodiment, the consumable product composition comprises the sweetener in a concentration from 0.01 wt % to 10 wt %, e.g., from 0.01 wt % to 1 wt %, from 0.02 wt % to 0.75 wt %, from 0.04 wt % to 0.3 wt %, from 0.1 wt % to 0.5 wt %, from 0.175 wt % to 0.26 wt %, from 0.01 wt % to 0.08 wt %, or from 0.04 wt % to 0.07 wt %. In terms of lower limits, the consumable product may comprise at least 0.01 wt % sweetener, e.g., at least 0.02 wt %, at least 0.04 wt %, at least 0.1 wt %, or at least 0.175 wt %. In terms of upper limits, the consumable product may comprise less than 10 wt % sweetener, e.g., less than 1 wt %, less than 0.75 wt %, less than 0.5 wt %, less than 0.3 wt %, less than 0.26 wt %, less than 0.08 wt %, or less than 0.07 wt %.

In one embodiment, the consumable product composition comprises the pregelatinized starch in a concentration from 0.05 wt % to 10 wt %, e.g., from 0.1 wt % to 8 wt %, from 0.1 wt % to 5 wt %, from 0.05 wt % to 0.5 wt %, from 0.1 wt % to 0.3 wt %, from 0.5 wt % to 5 wt %, or from 1 wt % to 3 wt %. In terms of lower limits, the consumable product may comprise at least 0.05 wt % pregelatinized starch, e.g., at least 0.05 wt %, at least 0.1 wt %, at least 0.3 wt %, at least 0.5 wt %, or at least 1 wt %. In terms of upper limits, the consumable product may comprise less than 10 wt % pregelatinized starch, e.g., less than 8 wt %, less than 5 wt %, less than 3 wt %, less than 0.5 wt %, less than 0.3 wt %.

In some embodiments, the at least one sweetener may function not only as a sweetener, but also as a sweetness enhancer.

In one embodiment, the consumable product is an emulsion product. In such embodiments, the emulsion product comprises the sweetener, the pregelatinized starch, and a carrier. Suitable carriers are available commercially. One preferred carrier is menthol. In a preferred embodiment, the consumable product is a menthol-containing emulsion product comprising the sweetener, the pregelatinized starch, and menthol.

In one embodiment, the emulsion product is formed by preparing a finely ground at least one sweetener, e.g., a sweetener having a low mean particle size, e.g., less than 50 microns, less than 25 microns, less than 10 microns, or less than 5 microns. The finely ground sweetener may be contacted with the carrier to form a suspension. In one embodiment, the carrier is heated, e.g., melted, prior to contact with the finely ground sweetener. In one embodiment, the suspension is then contacted with the pregelatinized starch to form the emulsion product.

Preferably, the finely ground sweetener comprises finely ground acesulfame potassium and the carrier comprises menthol. In a particular preferred embodiment, the finely ground sweetener comprises finely ground acesulfame potassium, sucralose and the carrier comprises menthol. The finely ground sweetener may be contacted with heated, e.g., melted menthol to form a suspension and the suspension may be contacted with the pregelatinized starch to form the menthol-containing emulsion product.

In one embodiment, the finely ground sweetener comprises finely ground sucrose.

The following consumable products and their ingredients are suitable for use in embodiments of the present invention.

Consumable products include all food products, including but not limited to cereal products, rice products, tapioca products, sago products, baker's products, biscuit products, pastry products, bread products, confectionery products, desert products, gums, chewing gums, chocolates, ices, honey products, treacle products, yeast products, baking-powder, salt and spice products, savoury products, mustard products, vinegar products, sauces (condiments), tobacco products, cigars, cigarettes, processed foods, cooked fruits and vegetable products, meat and meat products, jellies, jams, fruit sauces, egg products, milk and dairy products, yoghurts, cheese products, butter and butter substitute products, milk substitute products, soy products, edible oils and fat products, pharmaceuticals, instant powders for reconstitution (e.g. coffee beans, ground coffee, instant coffee, cacao beans, cacao powder, instant cacao, tea leaves, instant tea powder, dry iced tea powders), food extracts, plant extracts, meat extracts, condiments, sweeteners, nutraceuticals, gelatins, pharmaceutical and non-pharmaceutical gums, tablets, lozenges, drops, emulsions, elixirs, syrups and other preparations for making beverages, and combinations thereof.

Consumable products include without limitation, solid dry consumable products, dairy products, dairy-derived products and dairy-alternative products.

In another embodiment, the consumable product is a solid dry consumable product including but not limited to cereals, baked food products, biscuits, bread, breakfast cereal, cereal bar, energy bars/nutritional bars, granola, cakes, rice cakes, cookies, crackers, donuts, muffins, pastries, confectioneries, chewing gum, chocolate products, chocolates, fondant, candy, hard candy, marshmallow, pressed tablets, snack foods, botanical materials (whole or ground), and instant powders for reconstitution.

In another embodiment, the consumable product is selected from the group of a dairy product, dairy-derived product and dairy-alternative product, including but not limited to cultured milk product cultured with lactobacillus, yoghurt, yoghurt-based beverage, smoothy, lassi, milk shake, acidified milk, acidified milk beverage, butter milk, kefir, ice cream, dessert, sour cream, dip, salad dressing, cottage cheese, frozen yoghurt.

In another embodiment, the consumable products are dry powder beverages and the invention relates to dry powder beverages comprising a sweetener composition of the invention. In addition, the dry powder beverages may contain further substances including but not limited to acesulfame potassium, aspartame, apple flavor, ascorbic acid, citric acid, cherry flavor, malic acid, orange flavor, raspberry flavor, sodium chloride, trisodium citrate, tricalcium phosphate, titanium dioxide and xantham gum.

In another embodiment, the consumable product is iced tea powdered mix and the invention relates to iced tea powdered mix comprising a sweetener composition of the invention, preferably to iced tea and sugar free iced tea mix. In addition, the iced tea mix may contain further substances including but not limited to base with lemon flavor, base with tea component, citric acid, cyclamate, flavor, instant tea, lemon juice, maltodextrin, malic acid (e.g., powdered), saccharin, sucralose, sucrose, tea and tea extract.

In another embodiment, the consumable product is iced coffee powdered mix and the invention relates to iced coffee powdered mix comprising a sweetener composition of the invention. In addition, the iced coffee mix may contain further substances including but not limited to acesulfame potassium, aspartame, coffee extract, ethylmaltol, flavor and neohesperidine-DC.

In another embodiment, the consumable products are instant cake fillings and the invention relates to instant cake fillings comprising a sweetener composition of the invention. In addition, the cake fillings may contain further substances including but not limited to milk, isomalt, oligofructose, modified starch, flavors and colors. In another embodiment, the cake fillings may contain further substances including but not limited to raspberries, strawberry puree, polydextrose, isomalt, sorbitol, glycerin, fructose, pectin, locust bean gum, calcium chloride, sodium bicarbonate, citric acid and water.

In another embodiment, the consumable products are biscuits and the invention relates to biscuits comprising a sweetener composition of the invention. In addition, the biscuits may contain further substances including but not limited to isomalt, powdered isomalt, granulated isomalt, polydextrose, shortening, water, sodium bicarbonate, ammonium bicarbonate, skimmed milk powder, salt, flour, cake flour, flavor, inulin, wheat fiber, shortening, ground raisins, raisin paste, salt, oatrim gel, liquid whole eggs, liquid egg whites, powdered egg whites, egg yolk, vanilla, butter flavor, vanilla flavor, chocolate flavor, cocoa, high fructose corn syrup (HFCS), methocel, baking soda, cinnamon, sodium acid pyrophosphate, margarine spread, margarine, emulsifier, molasses, mono- and diglycerides, powdered cellulose, ground hazelnuts, hazelnuts, sorbitol, oat fiber, vital wheat gluten, chocolate chips, maltitol and fat replacer.

In another embodiment, the consumable products are cakes and the invention relates to cakes comprising a sweetener composition of the invention. In addition, the cakes may contain further substances including but not limited to baking powder, baking soda, blueberry flavor, all purpose flour, cake flour, diacetyl 4×, dextrose, dried butter flavor, flour, cellulose, crystalline fructose, emulsifier, egg whites solid, eggs, dried egg white, fat replacers such as inulin, isomalt, lecithin, milk, non fat dry milk, modified starch, maltodextrin, oligofructose, potato fiber, polydextrose, salt, shortening, crystalline sorbitol, sodium aluminium phosphate, sucrose, butter flavor, chocolate flavor, (dried) vanilla flavor, water, wheat fiber, xanthan gum and vegetable oil.

In another embodiment, the consumable products are bakery products other than cakes and the invention relates to bakery products other than cakes comprising a sweetener composition of the invention, preferably to light hot fudge toppings, tartlets with strawberry fillings, sugar free maple flavored syrups, sugar free dark chocolate coatings, sugar free chocolate syrups, reduced-calorie chocolate syrups, no sugar added caramel corn, light chocolate frostings, light caramel toppings and light apple tart. In addition, the bakery products may contain further substances including but not limited to acesulfame potassium, aspartame, baking powder, baking soda, disodium phosphate, maple flavor, caramel flavor, caramel color, flour, carrageenan, cocoa powder, cocoa butter, (microcrystalline) cellulose, citric acid, calcium chloride, crystalline fructose, fructose, chocolate liquor, eggs, dried egg white, fudge flavor, isomalt, lecithin, non fat dry milk, hydrogenated starch hydrolysate, margarine, modified starch, maltisorb, maltodextrin, nonfat dry milk, oligofructose, potassium sorbate, pectin, potato fiber, hydrogenated potato starch, polydextrose, skimmed milk powder, shortening, (crystalline) sorbitol, sodium benzoate, salt, sorbitol, potassium sorbate, (powdered) sucrose, butter flavor, chocolate flavor, vanillin, (dried) vanilla flavor, water, wheat fiber and xanthan gum.

In another embodiment, the consumable products are confectionary products and the invention relates to confectionary products comprising a sweetener composition of the invention, preferably to all confectionary products mentioned in the Directive 2003/115/EC of 22 Dec. 2003 and in the Directive 94/35/EC of 30 Jun. 2004 on sweeteners for use in foodstuffs, each of which are incorporated herein by reference. Examples include, but are not limited to, confectionaries (with or without added sugar), cocoa- or dried-fruit-based confectionaries, energy-reduced or with not added sugar, starch-based confectionaries, energy-reduced or with not added sugar, comets and wafers for ice-cream, with not added sugar, Essoblaten, cocoa-, milk-, dried-fruit- or fat-based sandwich spreads, energy-reduced or with not added sugar, breakfast cereals, e.g., with a fiber content of more than 15%, and containing at least 20% bran, energy-reduced or sugar-reduced, breath-freshening micro-sweets with or without added sugar, strongly flavored freshening throat pastilles with or without added sugar, chewing gum with or without added sugar, energy-reduced tablet form confectioneries, cider and perry, drinks consisting of a mixture of a non-alcoholic drink and beer, cider, perry, spirits or wine, spirit drinks containing less than 15% alcohol by volume, alcohol-free beer or beer with an alcohol content not exceeding 1.2% vol., “bière de table/Tafelbier/table beer” (original wort content less than 6%), except for “obergäriges Einfachbier”, beers with a minimum aciditiy of 30 milli-equivalents expressed as NaOH, brown beers of the “oud bruin” type, energy-reduced beer, edible ices, energy-reduced or sugar-reduced canned or bottled fruit, energy-reduced or with or without added sugar, energy-reduced jams, jellies and marmalades, energy-reduced fruit and vegetable preparations, sweet-sour preserves of fruit and vegetables, Feinkostsalat, sweet-sour preserves and semi-preserves of fish and marinades of fish, crustaceans and mollusks, energy-reduced soups, sauces, mustard, fine bakery products for special nutritional uses, foods intended for use in energy-restricted diets for weight reduction as referred to in Directive 1996/8/EC, dietary foods for special medical purposes as defined in Directive 1999/21/EC, food supplements as defined in Directive 2002/46/EC supplied in a liquid form, food supplements as defined in Directive 2002/46/EC supplied in a solid form, food supplements as defined in Directive 2002/46/EC, based on vitamins and/or mineral elements and supplied in a syrup-type or chewable form. These Directives are incorporated herein by reference. Particularly preferred confectionary products are sugar free hard candy, reduced calorie no sugar added hard candy, hard candies, sugar free milk chocolate, milk chocolate, sugar free gummy bear, reduced calorie no sugar added gummy bear, sugar free dark chocolate, reduced calorie no sugar added hard candy, reduced calorie no sugar added caramel, reduced calorie caramel, raspberry jellies, jellies, plain bitter chocolate, toffees, sugar-free rice cake, sugar free peppermint breathmint, sugar free orange chewy candy and sugar free jelly beans. In addition, the confectionary products may contain further substances including but not limited to butter fat, (caramel) flavor, citric acid (monohydrate), cherry flavor, chocolate liquor, cocoa butter, cocoa mass, color, corn syrup, (microcrystalline) cellulose, disodium phosphate, egg Albumen-dried, evaporated milk, gelatin, glycerol monostearate, gum Arabic, hydrogenated starch hydrolysate, hydrogenated fat, isomalt, lecithin, lemon oil, maltitol (syrup, powdered and/or granular), medium-grain brown rice, Korean black rice, maltol, mocha paste, neohesperidine-DC, orange flavor, pectin, peppermint flavor, polydextrose, raspberry puree, raspberry puree, salt, sodium caseinate, sorbitol (powder), starch, sucrose, vanillin, vegetable fat, whole milk powder, skimmed milk powder, water and xylitol.

In a preferred embodiment, the consumable product is a chewing gum and the sweetener is acesulfame potassium. In a preferred embodiment, the consumable product is a chewing gum composition comprising the inventive sweetener composition. In one embodiment, the sweetener composition may comprise acesulfame potassium, pregelatinized starch, and menthol flavoring.

In another embodiment, the consumable products are delicacies sauces and the invention relates to delicacies sauces comprising a sweetener composition of the invention, preferably to sugar reduced ketchup with sugar, no added sugar ketchup and tomato ketchup. In addition, the delicacies sauces may contain further substances including but not limited to citric acid, modified starch, mustard, onions, pectin, polydextrose, saccharine sodium, salt, spices, sucralose, sugar, thickener, tomato concentrate and vinegar.

In another embodiment, the consumable products are cereals and the invention relates to cereals comprising a sweetener composition of the invention.

In another embodiment, the consumable products are dairy products and the invention relates to dairy products comprising a sweetener composition of the invention, preferably to fruit quarks, whipped creams. In addition, the dairy products may contain further substances including but not limited to acesulfame potassium, aspartame, blackcurrant, blackberry, blueberry, cyclamate, flavor, fruit preparation, fruit juice concentrate, fructose, gelatin, inulin, oat, orange juice, pectin, raspberry, redcurrant, stabilizer, wheat fiber, water, quarks, yoghurt, whipped cream and whey.

In another embodiment, the consumable products are desserts and the invention relates to desserts comprising a sweetener composition of the invention, preferably to jellied red fruit cocktails, strawberry sorbet, (fat-free/sugar-free) instant pudding chocolate flavors, instant desserts, vanilla puddings, vanilla pudding—powder mixtures and litchee gelees. In addition, the desserts may contain further substances including but not limited to acesulfame potassium, aspartame, blackberries, brandy, citric acid, caramel color, color, cyclamate, chocolate flavor, cocoa powder, corn starch, disodium phosphate, emulsifier, fructose, granulated sugar, white soft sugar, agar powder, ingestible dextrin, mannan, maltodextrin, mono- and diglycerides, inulin, polydextrose, lemon juice, maltodextrin, milk modified food starch, polydextrose, raspberries, redcurrant juice, salt, soy lecithin, strawberries, strawberry puree, tetrasodium pyrophosphate, litchee flavor, vanilla flavor, wheat starch, water and xanthan gum.

As used herein, the term “desserts” includes, but is not limited to all desserts mentioned in the Directive 2003/115/EC of 22 Dec. 2003 and in the Directive 94/35/EC of 30 Jun. 2004 on sweeteners for use in foodstuffs. These Directives are incorporated herein by reference. Examples include, but are not limited to water-based flavored desserts, energy-reduced or with not added sugar, milk- and milk-derivative-paste preparations, energy-reduced or with no added sugar, fruit-and-vegetable-based desserts, energy-reduced or with no added sugar, egg-based desserts, energy-reduced or with no added sugar, cereal-based desserts, energy-reduced or with no added sugar, breakfast cereals or cereal-based products, energy-reduced or with no added sugar, fat-based desserts, energy-reduced or with no added sugar, edible ices, energy-reduced or with no added sugar, jams, jellies, marmalades and crystallized fruit, energy-reduced or with no added sugar, fruit preparations, energy-reduced or with no added sugar, and “snacks”, certain flavors of ready-to-eat, prepacked, dry, savoury starch products and coated nuts.

In another embodiment, the consumable product is water-based ice and the invention relates to water-based ice comprising a sweetener composition of the invention, preferably to “ice-pops” and no sugar added strawberry sorbet. In addition, the water-based ice may contain further substances including but not limited to acesulfame potassium, aspartame, citric acid, color, fruit concentrate, flavor, isomalt, lemon juice, polydextrose, strawberry puree, sorbitol, thickener and water.

In another embodiment, the consumable product is ice cream and the invention relates to ice cream comprising a sweetener composition of the invention. In addition, the ice-cream may contain further substances including but not limited to color, emulsifier, flavor, isomalt, milk fat, fat replacer, skim milk powder, polydextrose and lactitol.

In another embodiment, the consumable product is yoghurt and the invention relates to yoghurt comprising a sweetener composition of the invention. In addition, the yoghurt may contain further substances including but not limited to acesulfame potassium, alitame, aspartame, citric aid monohydrate, tri-calcium-dicitrate, cyclamate, Na-cyclamate, fruit preparation, high fructose corn syrup (HFCS), inulin, fructose, fructose syrup, oligofructose syrup, neohesperidine-DC, pectin-solution, saccharin, starch, strawberries, strawberry-flavor, sucralose, water and (low fat, preferably between 0.1% to 1.5% fat) yoghurt.

In another embodiment, the consumable products are jams and the invention relates to jams comprising a sweetener composition of the invention. In addition, the jams may contain further substances including but not limited to gelling agent, isomalt, maltitol, pectin, sorbitol and strawberries.

In another embodiment, the consumable product is chewing-gum and the invention relates to chewing-gum comprising the sweetener composition of the invention. In a preferred embodiment, the sweetener composition used with the chewing gum comprises acesulfame K. In another preferred embodiment, the sweetener composition used with the chewing gum comprises sucrose.

The amount of the sweetener composition in the consumable of the invention is dependent on the concentration of the natural and or artificial sweeteners contained therein as well as on the presence of further auxiliary substances such as carbon dioxide, flavors (e.g. spices, natural extract or oils), colors, acidulants (e.g. phosphoric acid and citric acid), preservatives, potassium, sodium.

In another embodiment, the consumable product is a dental product and the invention relates to a dental product comprising a sweetener composition of the invention. Dental products include, but are not limited to toothpaste, dental floss, mouthwash, denture adhesive, enamel whitener, fluoride treatments and oral care gels. These products are also known in the art.

In a preferred embodiment the consumable product is toothpaste and the invention relates to toothpaste comprising a sweetener composition of the invention. In addition, the toothpaste may contain further substances including but not limited to abrasive silica, dicalcium phosphate dehydrate, hydrated silica (thickener), ethyl alcohol, peppermint flavor, mint flavor, potassium sorbate, sodium lauryl sulphate, sodium carboxymethylcellulose, sodium monofluorophosphate, sodium monofluorophosphate, sorbitol solution, tetrasodium phosphate and titanium dioxide. In preferred embodiments, the consumable product is toothpaste and the sweetener composition (and the resultant toothpaste composition) comprises sweetener, pregelatinized starch, and menthol.

In another embodiment, the consumable product is a pharmaceutical product and the invention relates to a pharmaceutical product comprising a sweetener composition of the invention. Pharmaceutical products include but are not limited to over-the-counter and prescription drugs including but not limited to non-tobacco snuff, tobacco substitutes, chewable medications, cough syrups, throat sprays, throat lozenges, cough drops, antibacterial products, pill coatings, gel caplets, soluble fiber preparations, antacids, tablet cores, rapidly absorbed liquid compositions, stable foam compositions, rapidly disintegrating pharmaceutical dosage forms, beverage concentrates for medicinal purposes, aqueous pharmaceutical suspensions, liquid concentrate compositions, and stabilized sorbic acid solutions, phosphate buffers, saline solutions, emulsion, non-aqueous pharmaceutical solvents, aqueous pharmaceutical carriers, solid pharmaceutical carrier, and pharmaceutical preservatives/additives (antimicrobials, antioxidants, chelating agents, inert gases, flavoring agents, coloring agents).

In another embodiment, the consumable product is animal feed or animal food and the invention relates to animal feed or animal food comprising a sweetener composition of the invention.

In another aspect, the invention relates to a method of providing a sweetened consumable of the invention as defined above by admixing a sweetener composition of the invention as defined above to a consumable product.

In another aspect, the invention relates to a method of enhancing the taste sensations associated with flavor ingredients by admixing a sweetener composition of the invention as defined above with one or more flavor ingredients to provide a flavor-enhanced composition or consumable.

### EXAMPLES

Various chewing gum compositions were prepared as follows. Dissolved sweetener mixtures were prepared using the components listed in Table 1.

TABLE 1
Dissolved Sweetener Mixtures

| | Dissolved | Dissolved | Dissolved |
|---|---|---|---|
| | Mixture 1 | Mixture 2 | Mixture 3 |
| Acesulfame | 15 | — | 40 |
| Potassium, g | | | |
| Sucralose, g | 11.2 | 16.2 | — |
| Glycerol, g | 46 | 32 | — |
| Ethanol, g | — | — | 60 |
| Total | 72.2 | 48.2 | 100 |
| Dissolved | | | |
| Mixture, g | | | |

Each dissolved sweetener mixture was prepared by combining the acesulfame potassium, sucralose, and a diluent, e.g., glycerol, ethanol, or water, until the acesulfame potassium and the sucralose were dissolved to form a dissolved mixture.

Sweetener compositions 1-3 are in accordance with the present invention and were prepared using the components listed in Table 2.

TABLE 2
Sweetener Compositions

| | Sweetener | Sweetener | Sweetener |
|---|---|---|---|
| | Comp. 1 | Comp. 2 | Comp. 3 |
| Dissolved | 72.2 | 48.2 | 100 |
| Mixture, g | | | |
| Pregelatinized | 157.8 | 171.8 | 200 |
| Starch A, e.g. | | | |
| Starrier R ™, g | | | |
| Magnesium | 20 | 10 | 10 |
| Carbonate, g | | | |

For each sample, the dissolved mixture was added to a pregelatinized starch, e.g., Starrier R™ from Cargill, in the amounts shown in Table 2. The sweetener/pregelatinized starch combination was dried using the magnesium carbonate to obtain sweetener compositions 1-3, which are in accordance with the present invention. The resulting product was a powder.

Chewing gum compositions were prepared using the components listed in Table 3.

TABLE 3
Chewing Gum Compositions

| | Chewing | Chewing | Chewing | Comparative |
|---|---|---|---|---|
| | Gum | Gum | Gum | Chewing |
| | Com- | Com- | Com- | Gum |
| | position 1 | position 2 | position 3 | Composition A |
| Gum Base, g | 417.9 | 417.9 | 417.9 | 417.9 |
| (Cafosa | | | | |
| Solsona-T) | | | | |
| Sorbitol | 647.1 | 647.1 | 647.1 | 644.1 |
| Powder, g | | | | |
| (C*Sorbidex ™) | | | | |
| Maltitol Syrup, g | 61.1 | 61.1 | 61.1 | 61.1 |
| (C*Malidex ™) | | | | |
| Mannitol | 24.5 | 17.2 | 24.3 | 46.2 |
| Powder, g | | | | |
| (C*Mannidex ™) | | | | |
| Glycerine, g | 41.8 | 41.8 | 41.8 | 41.8 |
| Aspartame | 0.32 | 0.32 | 0.32 | 0.66 |
| 60-100 mesh, g | | | | |
| Sweetener | 19.50 | 26.73 | 19.65 | — |
| Composition | | | | |
| 1, 2, or 3, g | | | | |
| Acesulfame | — | — | — | 0.49 |
| Potassium | | | | |
| (no pregelatinized | | | | |
| starch) | | | | |
| Menthol, g | 1.0 | 1.0 | 1.0 | 1.0 |
| Peppermint | 30.5 | 30.5 | 30.5 | 30.59 |
| Flavor, g | | | | |
| (Optamint ® | | | | |
| Liquid) | | | | |

To prepare each chewing gum composition, the gum base was combined in a kneader with the maltitol syrup and the glycerin. Separately, the powdered ingredients, not including the flavor agent(s), were combined to form a powder mixture. Each chewing gum composition contained the respective sweetener composition, e.g., chewing gum composition 1 contained sweetener composition 1. A first portion of the powder mixture was then combined with the gum base and kneaded for 5 minutes. A second portion of the powder mixture was then added to the kneader and the resultant mixture was kneaded for 5 minutes. The remainder of the powder mixture was then added to the kneader and the resultant mixture was kneaded for an additional 5 minutes. The flavor agent(s) were then added and kneaded for an additional 5 minutes. The process yielded three chewing gum compositions in accordance with the present invention, chewing gum compositions 1-3. The process also yielded comparative chewing gum composition A.

The chewing gum compositions, as prepared, were tested by a trained sensory panel. The panel comprised trained sensory evaluators with above-average sensory skills The evaluators were trained for sensory test methodologies. The chewing gum compositions were evaluated over time, e.g., within the first 10 seconds of consumption and then 10 minute intervals. The chewing gum compositions were evaluated for impact, sweetness, bitterness, menthol-related effects, freshness, and cooling effects. Impact refers to a measurement of overall intensity of the chewing gum composition. Sweetness and bitterness are well known tastes. Menthol-related effects are measured based on the effects menthol crystals. Freshness refers to tastes and effects that develop in the nose and the throat (retro-nasal), and which simulate a clean mouth feel. Freshness may not relate to coolness. As one example the taste associated with peppermint and/or eucalyptus will demonstrate a high freshness level. A “warm mouth” feel or a sweet taste is not indicative of freshness. Freshness (or lack thereof) may depend on different aromatics. For example, high basic taste intensities may often be associated with low freshness. Cooling effects refers to a cooling of the teeth and/or mouth as a whole. For example, cooling effects may be characterized as feeling as if the mouth has been subjected to a cold water spray or an ice spray. In one case a high menthol level may be associated with a high level of cooling effects.

The panelists scored the samples on a scale of 0 to 10. “0” meant that the particular descriptor is not perceivable; “10” meant that the particular descriptor was perceived at a very high intensity.

All tests were conducted under controlled and standardized conditions based on international norms (DIN 10962 and ISO 8589). Room temperature and humidity were maintained at approximately 20° C. and between 40% and 70% relative humidity. Air was constantly exchanged.

Panelists were seated in sensory test cabins in order to allow undisturbed individual assessment. Lighting was identical for each panelist and the lighting varied from red-light to full day-light condition, depending on the time of day.

The chewing gum composition samples were prepared as discussed above and were distributed to the panelists. Pieces of the chewing gum compositions were served in clear plastic cups labelled with random, blind three digit codes. The data were collected on a computer. Time was measured with a digital stop-watch.

The palates of the panelists were neutralized between samples by: 1) establishing 15 minute breaks between sample consumption; and 2) consuming neutralizing food and drinks such as still water, cucumber, white baguette and unsalted rice crackers. However, in the last 5 minutes of a particular break, the panelists were allowed only water (no other food or drinks) in order to give the mouth time to recover.

The following tables summarize the mean scores for each descriptor for all included samples. The samples were tested for statistical significance using univariate analysis variance. The statistical significance for each sample is indicated by a “critical difference” measurement, which is listed in the tables below. The critical difference is the minimum difference between two samples required to show that the samples are statistically, significantly different. Also, a “descriptor discrimination” value was calculated for each descriptor. The descriptor discrimination for each sample is listed in the tables below. The descriptor discrimination indicates how many times the critical difference “fits” into the length of the distance between the highest and lowest score occurring between the tested samples for a particular descriptor. If the descriptor discrimination value is greater than 1, then the descriptor is overall a significantly discriminant one.

Table 4 shows the taste scores taken within the first 10 seconds of consumption.

TABLE 4
Taste Data--Start of Consumption-- Chewing Gum
Composition with Starrier R ™

| | Im- | Sweet- | Bitter- | Menthol | Fresh- | Cooling |
|---|---|---|---|---|---|---|
| | pact | ness | ness | Effects | ness | Effects |
| Comparative | 1.48 | 0.84 | 0.17 | 0.94 | 0.89 | 0.68 |
| Chewing Gum | | | | | | |
| Composition A | | | | | | |
| Chewing Gum | 1.41 | 0.81 | 0.35 | 0.85 | 0.52 | 0.34 |
| Composition 1 | | | | | | |
| Chewing Gum | 1.68 | 0.95 | 0.20 | 0.92 | 0.81 | 0.76 |
| Composition 2 | | | | | | |
| Chewing Gum | 1.47 | 0.67 | 0.36 | 0.97 | 0.67 | 0.65 |
| Composition 3 | | | | | | |
| Actual Difference | −0.07 | −0.03 | 0.18 | −0.09 | −0.37 | −0.34 |
| between 1 and A | | | | | | |
| Actual Difference | 0.2 | 0.11 | 0.03 | −0.02 | −0.08 | 0.08 |
| between 2 and A | | | | | | |
| Actual Difference | −0.01 | −0.17 | 0.19 | 0.03 | −0.22 | −0.03 |
| between 3 and A | | | | | | |
| Critical | 0.34 | 0.28 | 0.21 | 0.34 | 0.27 | 0.23 |
| Difference | | | | | | |
| Descriptor | 0.79 | 1 | 0.9 | 0.35 | 1.35 | 1.8 |
| Discrimination | | | | | | |

Table 5 shows the taste scores taken 10 minutes after start of consumption.

TABLE 5
Taste Data--10 Minutes after Consumption-- Chewing
Gum Composition with Starrier R ™

| | Im- | Sweet- | Bitter- | Menthol | Fresh- | Cooling |
|---|---|---|---|---|---|---|
| | pact | ness | ness | Effects | ness | Effects |
| Comparative | 3.21 | 0.59 | 2.82 | 2.62 | 2.31 | 3.25 |
| Chewing Gum | | | | | | |
| Composition A | | | | | | |
| Chewing Gum | 3.1 | 0.95 | 2.49 | 2.3 | 2.38 | 2.86 |
| Composition 1 | | | | | | |
| Chewing Gum | 3.01 | 0.85 | 2.45 | 2.33 | 2.1 | 3.07 |
| Composition 2 | | | | | | |
| Chewing Gum | 2.9 | 0.81 | 2.61 | 2.09 | 2.45 | 2.99 |
| Composition 3 | | | | | | |
| Actual Difference | −0.11 | 0.36 | −0.33 | −0.32 | 0.07 | −0.39 |
| between 1 and A | | | | | | |
| Actual Difference | −0.2 | 0.26 | −0.37 | −0.29 | −0.21 | −0.18 |
| between 2 and A | | | | | | |
| Actual Difference | −0.31 | 0.22 | −0.21 | −0.53 | 0.14 | −0.26 |
| between 3 and A | | | | | | |
| Critical | 0.34 | 0.23 | 0.34 | 0.3 | 0.36 | 0.4 |
| Difference | | | | | | |
| Descriptor | 0.91 | 1.57 | 1.09 | 1.78 | 0.96 | 0.96 |
| Discrimination | | | | | | |

As shown in Table 5, the actual differences in the sweetnesses of chewing gum compositions 1, 2, and 3 and the sweetness of comparative chewing gum composition A are particularly significant because these actual differences are similar to or higher than the critical difference (0.23). The fact that the actual differences are similar to or higher than the critical difference indicates that there are statistically significant taste differentiations between the chewing gum samples that employ the inventive sweetener compositions (with pregelatinized starch) and the chewing gum that employs a conventional sweetener composition, e.g., acesulfame K (without the pregelatinized starch). Specifically, the sweetnesses of the chewing gum samples that employ the inventive sweetener compositions are prolonged or extended as compared to chewing gum samples that employ conventional sweetener compositions.

Table 6 shows sweetness retention after extended consumption.

TABLE 6
Taste Data - Prolonged Sweetener Release Rate—
Chewing Gum Composition with Starrier R ™

| | | Sweetness | |
|---|---|---|---|
| | Initial | after 10 | Sweetness |
| | Sweetness | minutes | Retained, % |
| Comparative Chewing | 0.84 | 0.59 | 70.2 |
| Gum Composition A | | | |
| Chewing Gum | 0.81 | 0.95 | 117.3 |
| Composition 1 | | | |
| Chewing Gum | 0.95 | 0.85 | 89.5 |
| Composition 2 | | | |
| Chewing Gum | 0.67 | 0.81 | 120.9 |
| Composition 3 | | | |

As shown in Table 6, chewing gum compositions 1-3, show a beneficial effect and surprisingly and unexpectedly retain a significant amount of sweetness after extended consumption time, e.g., chewing. Comparative chewing gum composition A retains significantly less sweetness.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference. In addition, it should be understood that aspects of the invention and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the invention.

We claim:

1. A sweetener composition, comprising
at least one sweetener; and
a pregelatinized starch comprising particles each having a plurality of pores;
wherein at least 50% of the particles has an average particle size of at least 50 microns;
wherein sweetener is disposed in at least one of the pores.

2. The sweetener composition of claim 1, wherein the sweetener comprises acesulfame potassium.

3. The sweetener composition of claim 1, wherein the sweetener comprises a first sweetener and a second sweetener.

4. The sweetener composition of claim 1, wherein the plurality of pores has an average pore diameter ranging from 1 micron to 200 microns.

5. The sweetener composition of claim 1, wherein the particles have an average size ranging from 50 microns to 1000 microns.

6. The sweetener composition of claim 1, comprising from 1 wt % to 45 wt % of the sweetener based on the total weight of the sweetener composition.

7. The sweetener composition of claim 1, comprising from 50 wt % to 99 wt % of pregelatinized starch based on the total weight of the sweetener composition.

8. The sweetener composition of claim 1, wherein the sweetener is absorbed into the pores of the pregelatinized starch.

9. The sweetener composition of claim 1, wherein the sweetener composition comprises homogeneous particles comprising the sweetener and the pregelatinized starch.

10. The sweetener composition of claim 1, wherein the pregelatinized starch has a specific surface less than or equal to 0.5 m²/g.

11. The sweetener composition of claim 10, wherein the pregelatinized starch has a specific surface ranging from 0.05 m²/g to 0.5 m²/g.

12. The sweetener composition of claim 1, wherein the pregelatinized starch is non-granular.

13. The sweetener composition of claim 1, wherein the pregelatinized starch is granular.

14. The sweetener composition of claim 1, further comprising at least one additional sweetener.

15. The sweetener composition of claim 14, wherein the at least one additional sweetener is selected from the group consisting of abiziasaponin, abrusosides, in particular abrusoside A, abrusoside B, abrusoside C, abrusoside D, acesulfame potassium, advantame, albiziasaponin, alitame, aspartame, superaspartame, bayunosides, in particular bayunoside 1, bayunoside 2, brazzein, bryoside, bryonoside, bryonodulcoside, carnosifloside, carrelame, curculin, cyanin, chlorogenic acid, cyclamates and its salts, cyclocaryoside I, dihydroquercetin-3-acetate, dihydroflavenol, dulcoside, gaudichaudioside, glycyrrhizin, glycyrrhetin acid, gypenoside, hematoxylin, isomogrosides, in particular iso-mogroside V, lugduname, magap, mabinlins, micraculin, mogrosides (lo han guo), in particular mogroside IV and mogroside V, monatin and its derivatives, monellin, mukurozioside, naringin dihydrochalcone (NarDHC), neohesperidin dihydrochalcone (NDHC), neotame, osladin, pentadin, periandrin I-V, perillartine, D-phenylalanine, phlomisosides, in particular phlomisoside 1, phlomisoside 2, phlomisoside 3, phlomisoside 4, phloridzin, phyllodulcin, polpodiosides, polypodoside A, pterocaryosides, rebaudiosides, in particular rebaudioside A, rebaudioside B, rebaudioside C, rebaudioside D, rebaudioside F, rebaudioside G, rebaudioside H), rubusosides, saccharin and its salts and derivatives, scandenoside, selligueanin A, siamenosides, in particular siamenoside I, stevia, steviolbioside, stevioside and other steviol glycosides, strogines, in particular strogin 1, strogin 2, strogin 4, suavioside A, suavioside B, suavioside G, suavioside H, suavioside I, suavioside J, sucralose, sucronate, sucrooctate, talin, telosmoside A₁₅, thaumatin, in particular thaumatin I and II, trans-anethol, trans-cinnamaldehyde, trilobtain, D-tryptophane, erythritol, galactitol, hydrogenated starch syrups including maltitol and sorbitol syrups, inositols, isomalt, lactitol, maltitol, mannitol, xylitol, arabinose, dextrin, dextrose, fructose, high fructose corn syrup, fructooligosaccharides, fructooligosaccharide syrups, galactose, galactooligosaccharides, glucose, glucose and (hydrogenated) starch syrup s/hydrolysates, isomaltulose, lactose, hydrolysed lactose, maltose, mannose, rhamnose, ribose, sucrose, tagatose, trehalose and xylose, and combinations thereof, in particular the at least one additional sweetener is aspartame.

16. The sweetener composition of claim 14, wherein the additional sweetener is a caloric sweetener.

17. The sweetener composition of claim 14, wherein the additional sweetener is a non-caloric sweetener.

18. The sweetener composition of claim 1, further comprising a sweetness enhancer.

19. The sweetener composition of claim 1, further comprising an additional component selected from the group consisting of bubble forming agents, surfactants, emulsifiers, salts, fats, gums, and hydrocolloids.

20. The sweetener composition of claim 1, wherein the sweetener composition is a solid or a gel at ambient conditions.

21. The sweetener composition of claim 1, wherein the sweetener composition comprises acesulfame potassium as a first sweetener and sucralose as a second sweetener.

22. A process for controlling the release rate of taste sensations associated with at least one sweetener from a sweetener composition comprising the at least one sweetener, comprising the step of:
admixing the at least one sweetener with a pregelatinized starch comprising particles each having a plurality of pores; wherein at least 50% of the particles has an average particle size of at least 50 microns to form a release controlled sweetener composition;
wherein the at least one sweetener is disposed in at least one of the pores.

23. A process for controlling the release rate of taste sensations associated with at least one sweetener from a consumable product, comprising the step of:
combining the at least one sweetener, a pregelatinized starch, and the consumer product to form a released controlled consumer product;
wherein the pregelatinized starch comprises particles each having a plurality of pores
wherein at least 50% of the particles has an average particle size of at least 50 microns and,
wherein the at least one sweetener is disposed in at least one of the pores.

24. The process of claim 23, wherein the at least one sweetener and the pregelatinized starch are combined prior to addition to the consumer product.

25. A process for decreasing a release rate of at least one sweetener from a consumable product composition comprising a consumable product and at least one sweetener and having an initial release rate of sweetener from the consumable product composition, comprising the step of:
adding to the consumer product composition a pregelatinized starch comprising particles each having a plurality of pores wherein at least 50% of the particles has an average particle size of at least 50 microns in an amount effective to decrease the release rate of sweetener from the consumable product to final release rate
wherein sweetener is disposed in at least one of the pores.

26. A consumable product composition, comprising:
a consumable product; and
a sweetener composition comprising:
at least one sweetener; and
a pregelatinized starch comprising particles each having a plurality of pores;
wherein at least 50% of the particles has an average particle size of at least 50 microns;
wherein sweetener is disposed in at least one of the pores.

27. The consumable product composition of claim 26, wherein the consumable product provides an initial sweetness level.

28. The consumable product composition of claim 27, wherein the initial sweetness level decreases to a reduced sweetness level over time.

29. The consumable product composition of claim 28, wherein after a pre-determined period of time the reduced sweetness level is greater than 70% of the initial sweetness level.

30. The consumable product composition of claim 26, wherein sweetener is present in the consumable product composition in a concentration from 0.01 wt % to 10 wt %.

31. The consumable product composition of claim 26, wherein the consumable product is a solid dry consumable product selected from the group consisting of cereals, baked food products, biscuits, breads, breakfast cereals, cereal bars, energy bars, nutritional bars, granolas, cakes, rice cakes, cookies, crackers, donuts, muffins, pastries, confection, chewing gums, chocolate products, chocolates, fondants, candies, hard candies, marshmallows, pressed tablets, snack foods, botanical materials, and instant powders for reconstitution.

32. The consumable product composition of claim 26, wherein the consumable product is a dairy product, dairy-derived product and/or dairy-alternative product selected from the group consisting of cultured milk product cultured with lactobacillus, yoghurt, yoghurt-based beverage, smoothy, lassi, milk shake, acidified milk, acidified milk beverage, butter milk, kefir, ice cream, dessert, sour cream, dip, salad dressing, cottage cheese, frozen yoghurt.

33. The consumable product composition of claim 26, wherein the consumable product is a cereal.

34. The consumable product composition of claim 26, wherein the consumable product is a yoghurt.

35. The consumable product composition of claim 26, wherein the consumable product is a chewing-gum.

36. The consumable product composition of claim 26, wherein the consumable product is a dental product selected from the group consisting of toothpaste, dental floss, mouthwash, denture adhesive, enamel whitener, fluoride treatments and oral care gels.

37. The consumable product composition of claim 26, wherein the consumable product is a toothpaste.

38. The consumable product composition of claim 26, wherein the consumable product is an animal feed or animal food.

39. The consumable product composition of claim 26, wherein the consumable product is a chewing gum and the at least one sweetener comprises acesulfame potassium.

40. The consumable product composition of claim 26, wherein the consumable product is a chewing gum and the at least one sweetener comprises acesulfame potassium and sucralose.

41. The consumable product of claim 39, further comprising menthol.

42. A process for making a sweetener composition comprising the steps of:
pregelatinizing a starch to form a pregelatinized starch comprising particles each having a plurality of pores wherein at least 50% of the particles has an average particle size of at least 50 microns;
admixing at least one sweetener with the pregelatinized starch to form the sweetener composition;
wherein the at least one sweetener is disposed in at least one of the pores.

43. A process for making a sweetener composition comprising the steps of:
providing a pregelatinized starch comprising a plurality of pores having an average pore diameter ranging from 1 micron to 200 microns;
selecting an at least one sweetener based on the average pore diameter of the plurality of pores; and
admixing the selected at least one sweetener with the pregelatinized starch to form the sweetener composition;
wherein the at least one sweetener is disposed in at least one of the pores.
